(19) United States
(12) Patent Application Publication
(10) Pub. No.: US 2016/0049237 A1
(43) Pub. Date: Feb. 18, 2016

(54) ELECTRONIC COMPONENT

(71) Applicant: Murata Manufacturing Co., Ltd., Nagaokakyo-shi (JP)

(72) Inventor: Kuniaki YOSUI, Nagaokakyo-shi (JP)

(21) Appl. No.: 14/928,297

(22) Filed: Oct. 30, 2015

Related U.S. Application Data
(63) Continuation of application No. PCT/JP2014/067374, filed on Jun. 30, 2014.

(30) Foreign Application Priority Data
Jul. 11, 2013 (JP) 2013-145519

(51) Int. Cl. H01F 27/28

(52) U.S. Cl. CPC H01F 27/2804; H01F 2027/2809

(57) ABSTRACT

An electronic component includes a multilayer body including insulating layers stacked in a stacking direction, first and second linear conductors having different line widths and provided on a respective one of the insulating layers, and third and fourth linear conductors having different line widths and provided on a respective one of the insulating layers. The insulating layer(s) supporting the third and fourth linear conductors is/are at one side in the stacking direction of the insulating layer(s) supporting the first and the second linear conductors. In a planar view from the stacking direction, the first and the fourth linear conductors overlap each other, and the second and the third linear conductors overlap each other. The first, the second, the third and the fourth linear conductors are electrically connected to define a coil.

### BACKGROUND OF THE INVENTION

1. Field of the Invention

The present invention relates to an electronic component, and more particularly to an electronic component including a coil.

2. Description of the Related Art

As an example of conventional electronic devices, a high-frequency coil as disclosed in Japanese Patent Laid-Open Publication No. H05-36532 is well known. FIG. 16 is an exploded perspective view of the high-frequency coil 500.

As indicated in FIG. 16, the high-frequency coil 500 includes dielectric layers 502a and 502b, and coil patterns 504a and 504b. The coil patterns 504a and 504b are linear conductors turning clockwise on the dielectric layers 502a and 502b, respectively. The coil patterns 504a and 504b are connected to each other through a via-hole, thereby forming a coil.

In the high-frequency coil 500, the line width d1 of the coil pattern 504a is smaller than the line width d2 of the coil pattern 504b. When viewed from a layer stacking direction, the coil pattern 504a overlaps the coil pattern 504b so as not to protrude from the coil pattern 504b. Thereby, even if an error occurs in a step of stacking the dielectric layers 502a and 502b during a production process of the high-frequency coil 500, the square measure of the overlap area of the coil patterns 504a and 504b is unlikely to change. Accordingly, the floating capacitance between the coil patterns 504a and 504b is unlikely to change.

In the meantime, in order to obtain a large inductance value from the high-frequency coil 500, for example, each of the coil patterns 504a and 504b may be a spiral coil pattern. This, however, causes a problem that the size of the high-frequency coil 500 is increased. FIG. 17 is a sectional view of the high-frequency coil 500 in which spiral coil patterns 504a and 504b are used.

In the high-frequency coil 500 illustrated in FIG. 17, portions of the coil pattern 504a extending side by side with each other need to be at a certain distance from each other so as to prevent a short circuit. Likewise, portions of the coil patterns 504b extending side by side with each other need to be at a certain distance from each other so as to prevent a short circuit. Also, in order to arrange the coil pattern 504a to overlap the coil pattern 504b without protruding from the coil pattern 504b when viewed from the layer stacking direction, the distance d11 between the respective centers of the portions of the coil pattern 504a extending side by side with each other is equal or substantially equal to the distance d12 between the respective centers of the portions of the coil pattern 504b extending side by side with each other. Accordingly, the gap between the portions of the coil pattern 504a extending side by side with each other is greater than the gap between the portions of the coil pattern 504b extending side by side with each other, and therefore, in the high-frequency coil 500 illustrated in FIG. 17, the distance between the portions of the coil pattern 504a extending side by side with each other is greater than necessary. With regard to the high-frequency coil 500 illustrated in FIG. 17, as described above, it is necessary to design the high-frequency coil 500 based on the coil pattern 504b having a greater width of d2. This results in a problem that the dimensions of the high-frequency coil 500 in directions perpendicular to the layer stacking direction are increased.

### SUMMARY OF THE INVENTION

Preferred embodiments of the present invention provide an electronic component including a coil, which has a greatly reduced size.

An electronic component according to a first preferred embodiment includes a multilayer body including a plurality of insulating layers stacked on one another in a stacking direction; a first linear conductor provided on one of the insulating layers and having a first line width; a second linear conductor provided on one of the insulating layers and having a second line width smaller than the first line width; a third linear conductor provided on one of the insulating layers that is arranged at one side in the stacking direction of the insulating layer on which the first linear conductor is provided and the insulating layer on which the second linear conductor are provided, and having a third line width; and a fourth linear conductor provided on one of the insulating layers that is arranged at one side in the stacking direction of the insulating layer on which the first linear conductor is provided and the insulating layer on which the second linear conductor are provided, and having a fourth line width smaller than the third line width, wherein the first linear conductor and the second linear conductor are arranged in a widthwise direction of the first and the second linear conductors; the third linear conductor and the fourth linear conductor are arranged in a widthwise direction of the third and the fourth linear conductors; the first linear conductor and the fourth linear conductor overlap each other in a planar view from the stacking direction; the second linear conductor and the third linear conductor overlap each other in a planar view of the stacking direction; and the first, the second, the third and the fourth linear conductors are electrically connected to define a coil.

An electronic component according to a second preferred embodiment includes a multilayer body including a plurality of insulating layers, stacked on one another in a stacking direction; a first linear conductor provided on one of the insulating layers and having a first line width; a second linear conductor provided on one of the first insulating layers and having a second line width smaller than the first line width; a third linear conductor provided on one of the insulating layers that is arranged at one side in the stacking direction of the insulating layer on which the first linear conductor is provided and the insulating layer on which the second linear conductor are provided, and having a third line width; and a fourth linear conductor provided on one of the insulating layers that is arranged at one side in the stacking direction of the insulating layer on which the first linear conductor is provided and the insulating layer on which the second linear conductor are provided, and having a fourth line width smaller than the third line width, wherein the first linear conductor and the second linear conductor are arranged in a widthwise direction of the first and the second linear conductors; the third linear conductor and the fourth linear conductor are arranged in a widthwise direction of the third and the fourth linear conductors; the first linear conductor and the fourth linear conductor overlap each other in a planar view from the stacking direction; the second linear conductor and the third linear conductor overlap each other in a planar view of the stacking direction; the first linear conductor and the second linear conductor are electrically connected to define a first coil; and the third linear conductor and the fourth linear conductor are electrically connected to define a second coil, to define a common-mode choke coil in conjunction with the first coil.

Preferred embodiments of the present invention achieve downsizing of an electronic component.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of an electronic component according to a first preferred embodiment of the present invention.

FIG. 2 is an exploded perspective view of the electronic component according to the first preferred embodiment of the present invention.

FIG. 3A is a sectional view of the electronic component cut along the line A-A.

FIG. 3B is a plan view of coil conductors of the electronic component.

FIG. 4 is a sectional view of the electronic component indicating a step of a production process.

FIG. 5 is a sectional view of the electronic component indicating a step of a production process.

FIG. 6 is a sectional view of the electronic component indicating a step of a production process.

FIG. 7A is a sectional view of an electronic component according to a comparative example.

FIG. 7B is a sectional view of an electronic component having the same kind of structure as the electronic component according to the first preferred embodiment of the present invention.

FIG. 8A is an exploded perspective view of an electronic component according to a second preferred embodiment of the present invention.

FIG. 8B is a plan view of coil conductors of the electronic component.

FIG. 8C is a plan view of the coil conductors of the electronic component.

FIG. 9 is a perspective view of an electronic component according to a third preferred embodiment of the present invention.

FIG. 10A is an exploded perspective view of an electronic component according to a third preferred embodiment of the present invention.

FIG. 10B is a plan view of coil conductors of the electronic component.

FIG. 11A is an exploded perspective view of an electronic component according to a fourth preferred embodiment of the present invention.

FIG. 11B is a plan view of coil conductors of the electronic component.

FIG. 11C is a plan view of the coil conductors of the electronic component.

FIG. 12 is a perspective view of an electronic component according to a fifth preferred embodiment of the present invention.

FIG. 13A is an exploded perspective view of the electronic component according to the fifth preferred embodiment of the present invention.

FIG. 13B is a plan view of linear conductors of the electronic component.

FIG. 14 is a sectional view of the electronic component cut along the line A-A.

FIG. 15A is a sectional view of the electronic component cut along the line B-B.

FIG. 15B is a perspective view of an electronic component according to a sixth preferred embodiment of the present invention.

FIG. 16 is an exploded perspective view of a high-frequency coil disclosed in Japanese Patent Laid-Open Publication No. H05-36532.

FIG. 17 is a sectional view of a high-frequency coil using spiral coil patterns.

### DETAILED DESCRIPTION OF THE PREFERRED EMBODIMENTS

### First Preferred Embodiment

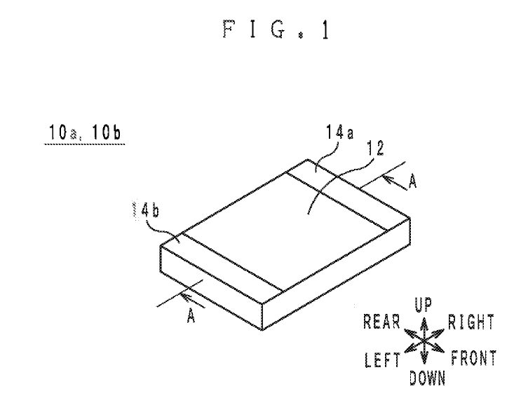

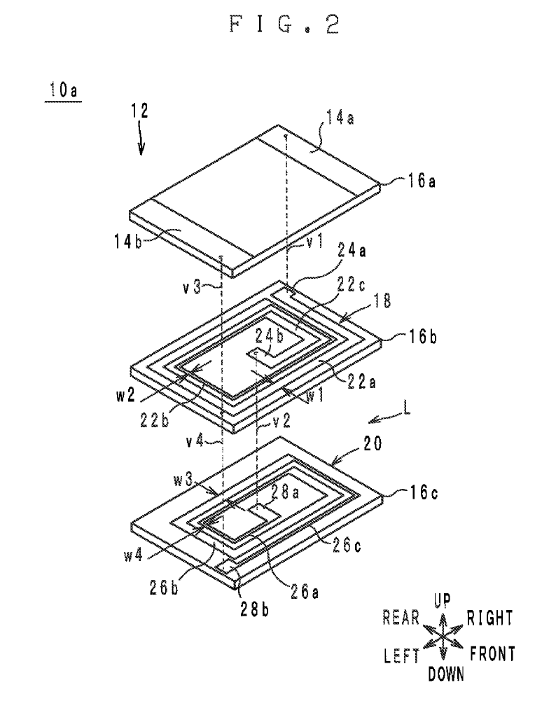

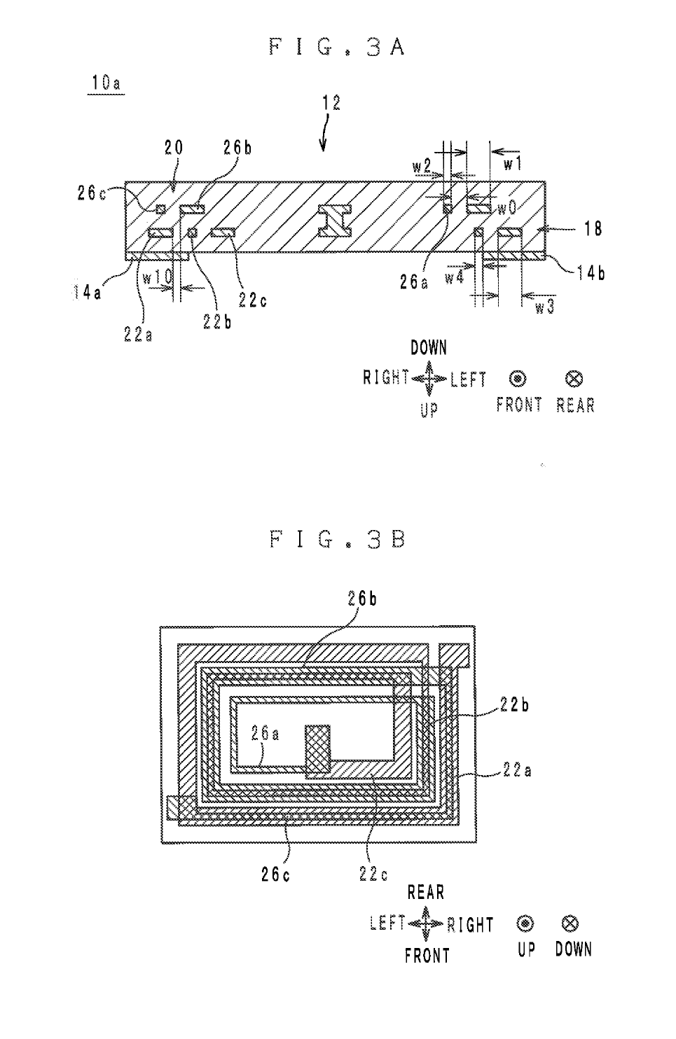

An electronic component according to a first preferred embodiment of the present invention will hereinafter be described with reference to the drawings. FIG. 1 is a perspective view of the electronic component 10a according to the first preferred embodiment. FIG. 2 is an exploded perspective view of the electronic component 10a according to the first preferred embodiment. FIG. 3A is a sectional view of the electronic component 10a cut along the line A-A. FIG. 3B is a plan view of coil conductors 18 and 20 of the electronic component 10a. In the following description, the layer stacking direction of the electronic component 10a is referred to as an up-down direction. In a top-down planar view, the direction in which longer sides of the electronic component 10a extend is referred to as a right-left direction, and the direction in which shorter sides of the electronic component 10a extend is referred to as a front-rear direction.

The electronic component 10a includes a multilayer body 12, external electrodes 14a and 14b, and a coil L. As seen in FIGS. 1 and 2, the multilayer body 12 preferably is a rectangular or substantially rectangular plate in a top-down planar view. The multilayer body 12 includes dielectric (insulating) layers 16a-16c stacked in this order from the top to the bottom. The dielectric layers 16a-16c preferably are rectangular or substantially rectangular and are made of a flexible dielectric material, for example, liquid crystal polymer. The dielectric layers 16a-16c are flexible, and accordingly, the multilayer body 12 is flexible. In the following description, the upper surface of each of the dielectric layers 16a-16c is referred to as a front surface, and the lower surface of each of the dielectric layers 16a-16c is referred to as a back surface.

The external electrodes 14a and 14b are provided on the front surface of the dielectric layer 16a, and each of the external electrodes 14a and 14b preferably has a rectangular or substantially rectangular shape that is long in the front-rear direction. The external electrode 14a extends along a right shorter side of the dielectric layer 16a. The external electrode 14b extends along a left shorter side of the dielectric layer 16a. The external electrodes 14a and 14b are formed, for example, by plating a copper foil with Ni and Sn.

The coil L includes coil conductors 18 and 20, and via-hole conductors v1-v4. The coil conductor 18 is provided on the front surface of the dielectric layer 16b and is made of a copper foil, for example. The coil conductor 18 includes linear conductive portions 22a-22c and connection conductive portions 24a and 24b. In a top-down planar view, the coil conductor 18 has a spiral shape spiraling clockwise from the outer circumference toward the center. In the following description, the upstream edge of the clockwise spiral of the coil conductor 18 or each of the linear conductive portions 22a-22c is referred to as an upstream edge, and the downstream edge of the clockwise spiral of the coil conductor 18 or each of the linear conductive portions 22a-22c is referred to as a downstream edge.

The linear conductive portion 22a has a length corresponding to substantially one turn and a line width of w1. The length corresponding to one turn means one turn of the spiral coil conductor 18. Specifically, the linear conductive portion 22a extends along the right shorter side, the front longer side, the left shorter side and the rear longer side of the dielectric layer 16b. The upstream edge and the downstream edge of the linear conductive portion 22a are located near the right rear corner of the dielectric layer 16b. However, the upstream edge of the linear conductive portion 22a and the downstream edge of the linear conductive portion 22a are separate from each other.

The linear conductive portion 22b has a length corresponding to substantially one turn and a line width of w2. The width w2 is smaller than the width w1. Specifically, the linear conductive portion 22b is arranged at the inner side of the linear conductive portion 22a to define an inner portion of the spiral coil conductor 18 than the linear conductive portion 22a. The linear conductive portion 22b extends along the right shorter side, the front longer side, the left shorter side and the rear longer side of the dielectric layer 16b. Accordingly, the linear conductive portion 22b extends parallel or substantially parallel to the linear conductive portion 22a keeping a constant or substantially constant gap of w0 (see FIG. 3A) with the linear conductive portion 22a. The upstream edge and the downstream edge of the linear conductive portion 22b are located near the right rear corner of the dielectric layer 16b. However, the upstream edge of the linear conductive portion 22b and the downstream edge of the linear conductive portion 22b are separate from each other. The upstream edge of the linear conductive portion 22b is connected to the downstream edge of the linear conductive portion 22a.

The linear conductive portion 22c has a length smaller than one turn and a line width of w1. Specifically, the linear conductive portion 22c is arranged at the inner side of the linear conductive portion 22b to define an inner portion of the spiral coil conductor 18 than the linear conductive portion 22b. The linear conductive portion 22c extends along the right shorter side and the right half of the front longer side of the dielectric layer 16b. Accordingly, the linear conductive portion 22c extends parallel or substantially parallel to the linear conductive portion 22b keeping a constant or substantially constant gap of w0 (see FIG. 3A) with the linear conductive portion 22b. The upstream edge of the linear conductive portion 22c is located near the right rear corner of the dielectric layer 16b. The downstream edge of the linear conductive portion 22c is located near the center (the intersection point of the diagonal lines) of the dielectric layer 16b. The upstream edge of the linear conductive portion 22c is connected to the downstream edge of the linear conductive portion 22b.

As described above, the linear conductive portion 22a having a line width of w1, the linear conductive portion 22b having a line width of w2 and the linear conductive portion 22c having a line width of w1 are connected in this order (that is, linear conductive portions having line widths of w1 and linear conductive portions having line widths of w2 are connected alternately) to define the coil conductor 18 in a spiral shape. The length of the linear conductive portion 22c is smaller than the length of the linear conductive portion 22b. Therefore, almost the entire length of the linear conductive portion 22c extends along the linear conductive portion 22b. The length of the linear conductive portion 22a is equal or substantially equal to the length of the linear conductive portion 22b (corresponding to about one turn). Therefore, almost the entire length of the linear conductive portion 22b extends along the linear conductive portion 22a. Accordingly, in the coil conductor 18, the linear conductive portion 22a having a line width of w1, the linear conductive portion 22b having a line width of w2 and the linear conductive portion 22c having a line width of w1 are arranged in this order (that is, linear conductive portions having line widths of w1 and linear conductive portions having line widths of w2 are arranged alternately) from the outer circumference toward the center. As illustrated in FIG. 3A, in the coil conductor 18, the linear conductive portion 22a having a line width of w1, the linear conductive portion 22b having a line width of w2 and the linear conductive portion 22c having a line width of w1 are arranged in this order (that is, linear conductive portions having line widths of w1 and linear conductive portions having line widths of w2 are arranged alternately) in a widthwise direction with uniform or substantially uniform gaps of w0 therebetween. The widthwise direction is a direction perpendicular or substantially perpendicular to the extending direction of the linear conductive portions 22a-22c. In FIG. 3A, the widthwise direction is the right-left direction, for example.

The connection conductive portion 24a is connected to the upstream edge of the linear conductive portion 22a and is arranged at the rear right corner of the dielectric layer 16b. The connection conductive portion 24b is connected to the downstream edge of the linear conductive portion 22c and is arranged in the center (on the intersection point of the diagonal lines) of the dielectric layer 16b.

The coil conductor 20 preferably is provided on the front surface of the dielectric layer 16c and is made of a copper foil, for example. The coil conductor 20 includes linear conductive portions 26a-26c and connection conductive portions 28a and 28b. In a top-down planar view, the coil conductor 20 has a spiral shape spiraling clockwise from the center toward the outer circumference. In the following description, the upstream edge of the clockwise spiral of the coil conductor 20 or each of the linear conductive portions 26a-26c is referred to as an upstream edge, and the downstream edge of the clockwise spiral of the coil conductor 20 or each of the linear conductive portions 26a-26c is referred to as a downstream edge.

The linear conductive portion 26a has a length shorter than one turn and a line width of w4. Specifically, the linear conductive portion 26a extends along the left half of the front longer side, the left shorter side and the rear longer side of the dielectric layer 16c. The upstream edge of the linear conductive portion 26a is located near the center of the dielectric layer 16c. The downstream edge of the linear conductive portion 26a is located at the right rear corner of the dielectric layer 16c.

The linear conductive portion 26b has a length substantially corresponding to one turn and a line width of w3. The width w4 is smaller than the width w1 and is smaller than the width w3. In this preferred embodiment, the width w3 is equal or substantially equal to the width w1, and the width w4 is equal or substantially equal to the width w2. Specifically, the linear conductive portion 26b is arranged at the outer side of the linear conductive portion 26a to define an outer portion of the coil conductor 20 than the linear conductive portion 26a. The linear conductive portion 26b extends along the right shorter side, the front longer side, the left shorter side and the rear longer side of the dielectric layer 16c. Accordingly, the linear conductive portion 26b extends parallel or substantially parallel to the linear conductive portion 26a keeping a constant or substantially constant gap of w0 (see FIG. 3A) with the linear conductive portion 26a. The upstream edge and the downstream edge of the linear conductive portion 26b are located near the right rear corner of the dielectric layer 16c. The upstream edge of the linear conductive portion 26b and the downstream edge of the linear conductive portion 26b are separate from each other. The upstream edge of the linear conductive portion 26b is connected to the downstream edge of the linear conductive portion 26a.

The linear conductive portion 26c has a length shorter than one turn and a line width of w4. Specifically, the linear conductive portion 26c is arranged at the outer side of the linear conductive portion 26b to define an outer portion of the coil conductor 20 than the linear conductive portion 26b. The linear conductive portion 26c extends along the right shorter side and the front longer side of the dielectric layer 16c. Accordingly, the linear conductive portion 26c extends parallel or substantially parallel to the linear conductive portion 26b keeping a constant or substantially constant gap of w0 (see FIG. 3A) with the linear conductive portion 26b. The upstream edge of the linear conductive portion 26c is located at the right rear corner of the dielectric layer 16c. The downstream edge of the linear conductive portion 26c is located at the left front corner of the dielectric layer 16c. The upstream edge of the linear conductive portion 26c is connected to the downstream edge of the linear conductive portion 26b.

As described above, the linear conductive portion 26a having a line width of w4, the linear conductive portion 26b having a line width of w3 and the linear conductive portion 26c having a line width of w4 are connected in this order (that is, linear conductive portions having line widths of w4 and linear conductive portions having line widths of w3 are connected alternately) to define the coil conductor 20 in a spiral shape. The length of the linear conductive portion 26a is smaller than the length of the linear conductive portion 26b. Therefore, almost the entire length of the linear conductive portion 26a extends along the linear conductive portion 26b. The length of the linear conductive portion 26c is equal or substantially equal to the length of the linear conductive portion 26b (corresponding to about one turn). Therefore, almost the entire length of the linear conductive portion 26b extends along the linear conductive portion 26c. Accordingly, in the coil conductor 20, the linear conductive portion 26a having a line width of w4, the linear conductive portion 26b having a line width of w3 and the linear conductive portion 26c having a line width of w4 are arranged in this order (that is, linear conductive portions having line widths of w4 and linear conductive portions having line widths of w3 are arranged alternately) from the center toward the outer circumference. As illustrated in FIG. 3A, in the coil conductor 20, the linear conductive portion 26a having a line width of w4, the linear conductive portion 26b having a line width of w3 and the linear conductive portion 26c having a line width of w4 are arranged in this order (that is, linear conductive portions having line widths of w4 and linear conductive portions having line widths of w3 are arranged alternately) in a widthwise direction with uniform or substantially uniform gaps of w0 therebetween. The widthwise direction is a direction perpendicular or substantially perpendicular to the extending direction of the linear conductive portions 26a-26c. In FIG. 3A, the widthwise direction is the right-left direction, for example.

The connection conductive portion 28a is connected to the upstream edge of the linear conductive portion 26a and is located in the center of the dielectric layer 16c. The connection conductive portion 28b is connected to the downstream edge of the linear conductive portion 26c and is located at the left front corner of the dielectric layer 16c.

As seen in FIGS. 2, 3A and 3B, in a top-down planar view, the linear conductive portion 22a and the linear conductive portion 26c overlap each other. In a top-down planar view, the linear conductive portion 26c does not protrude from the linear conductive portion 26a in the widthwise direction. As seen in FIGS. 2, 3A and 3B, in a top-down planar view, the linear conductive portion 22b and the linear conductive portion 26b overlap each other. In a top-down planar view, the linear conductive portion 22b does not protrude from the linear conductive portion 26b in the widthwise direction.

As seen in FIGS. 3A and 3B, in a top-down planar view, the linear conductive portions 22a, 22c and 26b do not overlap one another. The linear conductive portions 22a, 22c and 26b are arranged in the widthwise direction with uniform or substantially uniform gaps of w10 therebetween.

The via-hole conductor v1 pierces through the dielectric layer 16a in the up-down direction to connect the external electrode 14a to the connection conductive portion 24a. The via-hole conductor v2 pierces through the dielectric layer 16b in the up-down direction to connect the connection conductive portion 24b to the connection conductive portion 28a. The via-hole conductors v3 and v4 pierce through the dielectric layers 16a and 16b, respectively, in the up-down direction to define one via-hole conductor. The via-hole conductor v3 is connected to the external electrode 14b, and the via-hole conductor v4 is connected to the connection conductive portion 28b. Accordingly, the coil L is connected between the external electrodes 14a and 14b.

With regard to the electronic component 10a having the structure above, the top surface is used as a mounting surface. Specifically, the electronic component 10a is mounted on a circuit board such that the top surface thereof faces the circuit board.

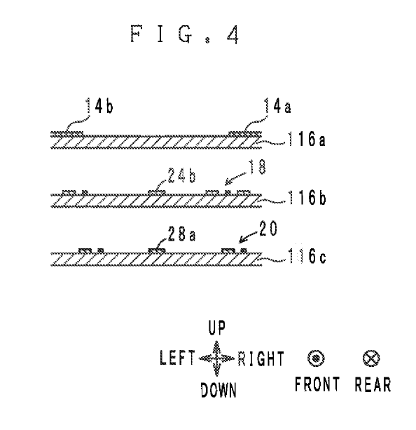

A non-limiting example of a production process of the electronic component 10a will hereinafter be described with reference to the drawings. FIGS. 4 through 6 are sectional views indicating steps of a production process of the electronic component 10a. In the following, a process of producing one electronic component 10a will be described as an example. Practically, however, a plurality of electronic components 10a preferably are produced at one time by stacking large-size dielectric sheets and by cutting the stacked body.

First, thermoplastic resin sheets 116a-116c, each having a copper foil (metal film) on the front surface, are prepared as sheets to be used as the dielectric layers 16a-16c respectively. The sheets 116a-116c to be used as the dielectric layers 16a-16c respectively are large-size sheets, each of which is large enough for a plurality of dielectric layers 16a, 16b or 16c. Copper foils are applied to the respective front surfaces of the sheets 116a-116c. The surfaces of the copper foils on the sheets 116a-116c are galvanized for corrosion control, and thereby, the surfaces of the copper foils are smoothened. The thermoplastic resin is liquid polymer, for example. The copper foils have thicknesses within a range from about 10 μm to about 20 μm, for example.

Next, as illustrated in FIG. 4, the copper foil on the front surface of the sheet 116a is patterned to form the external electrodes 14a and 14b on the sheet 116a. Specifically, on the front surface of the copper foil on the sheet 116a, resists having the same shapes of the external electrodes 14a and 14b indicated in FIG. 2 are printed. Then, the copper foil is etched, and the portion of the copper foil uncovered by the resists is removed. Thereafter, a resist remover is sprayed on the resists, and the resists are removed. In this way, the external electrodes 14a and 14b as indicated in FIG. 2 are formed on the front surface of the sheet 116a by photolithography.

Next, as illustrated in FIG. 4, the coil 18 is formed on the front surface of the sheet 116b. Also, the coil 20 is formed on the front surface of the sheet 116c. The processes of forming the coil conductors 18 and 20 are the same as the process of forming the external electrodes 14a and 14b, and description of the processes of forming the coil conductors 18 and 20 are omitted.

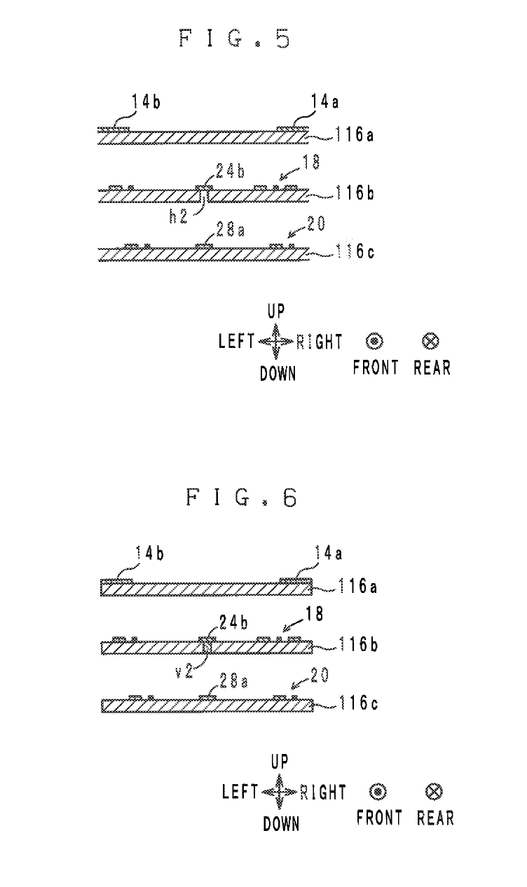

Next, as illustrated in FIG. 5, each of the sheets 116a and 116b is irradiated with a laser beam from the back surface, and thereby, through holes h1-h4 are formed. (Only the through hole h1 is indicated in FIG. 5.) Further, as illustrated in FIG. 6, the through holes h1-h4 are filled with a conductive paste.

Next, the sheets 116a-116c are stacked in this order from the top to the bottom, and the stack of sheets 116a-116c is subjected to a pressure-bonding treatment and a heating treatment. As a result, the boundary portions of the sheets 116a-116c are softened and melted, and thereafter solidified. In this way, the sheets 116a-116c are bonded together. In the meantime, the conductive paste filled in the through holes h1-h4 is solidified by the heat during the heating treatment, and thus, the via-hole conductors v1-v4 are formed. Through the process above, a mother multilayer body is obtained.

Next, the mother multilayer body is cut into a plurality of multilayer bodies 12. Thereafter, the copper foils 14 to be used as the external electrodes 14a and 14b are plated with Ni and Sn. Thus, the electronic component 10a is obtained.

In the electronic device 10a having the structure above, the linear conductive portions 22b and 26c are arranged to overlap the linear conductive portions 26b and 22a, respectively, without protruding in the widthwise direction. Accordingly, even if a stacking error occurs during fabrication of the multilayer body 12, the risk of protrusions of the linear conductive portions 22b and 26c from the linear conductive portions 26b and 22a, respectively, in the widthwise direction can be reduced. Consequently, the risk of a change in the square measure of the overlap area of the linear conductive portions 22b and 26b and a change in the square measure of the overlap area of the linear conductive portions 26c and 22a can be reduced. Hence, in the electronic component 10a, the risk of a change in the floating capacitance between the coil conductors 18 and 20 due to a stacking error during fabrication of the multilayer body 12 can be reduced.

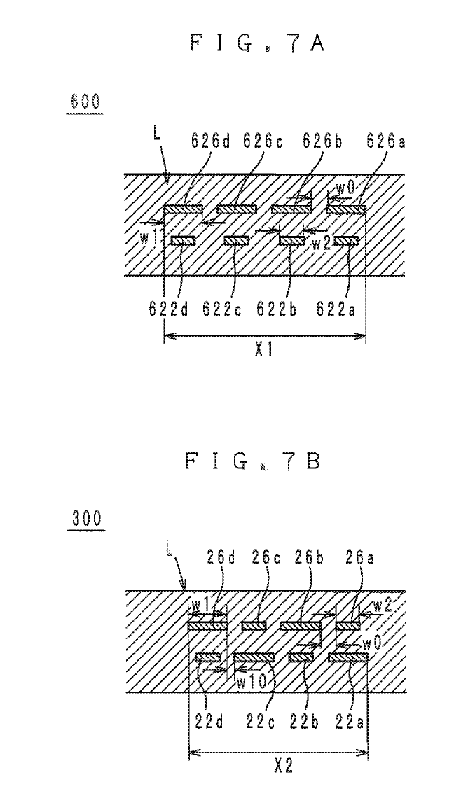

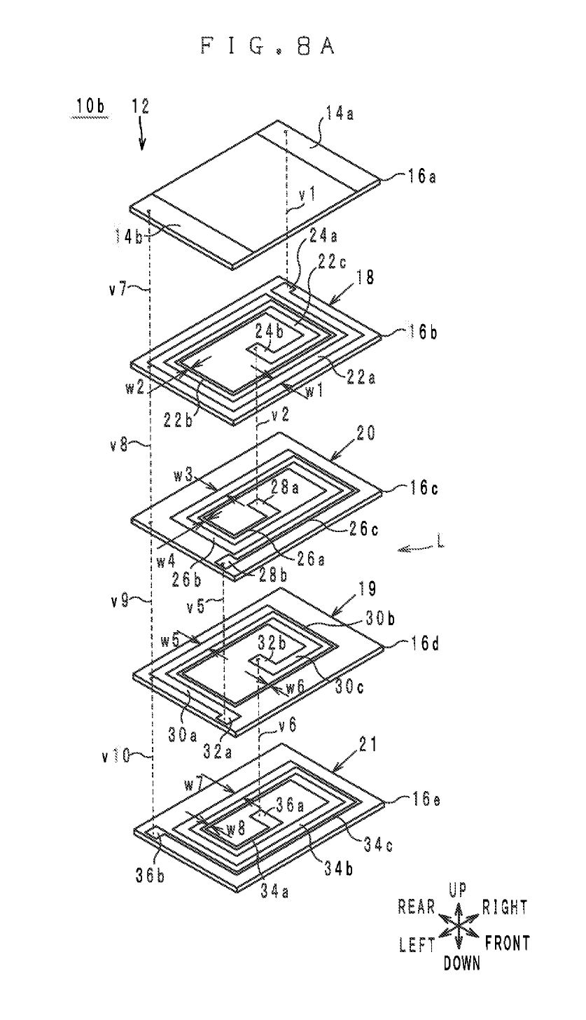

Also, it is possible to downsize the electronic component 10a as will be described below. FIG. 7A is a sectional view of an electronic component 600 according to a comparative example. FIG. 7B is a sectional view of an electronic component 300 having the same kind of structure as the electronic component 10a.

First, the electronic component 600 according to the comparative example is described. In the electronic component 600 according to the comparative example, four linear conductive portions 622a-622d are arranged in the widthwise direction, and four linear conductive portions 626a-626d are arranged in the widthwise direction. The linear conductive portions 626a-626d have line widths of w1, and the linear conductive portions 622a-622d have line widths of w2. In a top-down planar view, the linear conductive portions 626a-626d are arranged in the widthwise direction with uniform or substantially uniform gaps of w0 therebetween.

Next, the electronic component 300 is described. The electronic component 300 has the same kind of structure as the electronic component 10a. However, the number of turns of the coil conductor 18 and the number of turns of the coil conductor 20 in the electronic component 300 are increased as compared to those in the electronic component 10a. In the electronic component 300, four linear conductive portions 22a-22d are arranged in the widthwise direction, and four linear conductive portions 26a-26d are arranged in the widthwise direction. The linear conductive portions 22b, 22d, 26a and 26c have line widths of w2, and the linear conductive portions 22a, 22c, 26b and 26d have line widths of w1. Thus, in the electronic component 300, the linear conductive portions 22a and 22c having relatively great line widths and the linear conductive portions 22b and 22d having relatively small line widths are arranged alternately in the widthwise direction. In the same way, the linear conductive portions 26a and 26c having relatively small line widths and the linear conductive portions 26b and 26d having relatively great line widths are arranged alternately in the widthwise direction. Also, the linear conductive portions 26a-26d overlap the linear conductive portions 22a-22d, respectively. In a top-down planar view, the linear conductive portion 26a is separate from the linear conductive portion 26b in the widthwise direction with a gap of w0. In a top-down planar view, the linear conductive portion 22b is separate from the linear conductive portion 22c in the widthwise direction with a gap of w0. In a top-down planar view, the linear conductive portion 26c is separate from the linear conductive portion 26d in the widthwise direction with a gap of w0. Also, in a top-down planar view, the linear conductive portion 22a is separate from the linear conductive portion 26b in the widthwise direction with a gap of w10. Likewise, in a top-down planar view, the linear conductive portion 22c is separate from the linear conductive portion 26b in the widthwise direction with a gap of w10. Also, in a top-down planar view, the linear conductive portion 22c is separate from the linear conductive portion 26d in the widthwise direction with a gap of w10.

In the electronic component 600 described above, the length (the dimension in the right-left direction) X1 of the space where the coil L is formed is expressed as follows.

X1=4×w1+3×w0 (1)

In the electronic device 300 described above, the length (the dimension in the right-left direction) X2 of the space where the coil L is formed is expressed as follows.

X2=4×w1+3×w10 (2)

The gaps w0 are determined to be such a value as to prevent a short circuit between each of the linear conductive portions 626a-626d and adjacent linear conductive portions. The gaps w10 are determined to be such a value as to reduce the risk of changes in the capacitance between the linear conductive portions 22a and 26b, in the capacitance between the linear conductive portions 22c and 26b and in the capacitance between the linear conductive portions 22c and 26d. In either of the electronic components 300 and 600, prevention of short circuits is more important than reduction of the risk of changes in the capacitance. Therefore, the gaps w0 are determined to be greater than the gaps w10. Accordingly, the length X2 is shorter than the length X1. Hence, the electronic component 300 (electronic component 10a) is made smaller than the electronic component 600.

In the electronic component 10a, the linear conductive portions 22a, 22b and 26b have lengths corresponding to substantially one turn. If the lengths of the linear conductive portions 22a, 22b and 26b are more than one turn, in the coil conductor 18, the linear conductive portion 22a having a line width of w1, the linear conductive portion 22b having a line width of w2 and the linear conductive portion 22c having a line width of w1 will not be arranged in this order in the widthwise direction. In this case, in the coil conductor 20 also, the linear conductive portion 26a having a line width of w4, the linear conductive portion 26b having a line width of w3 and the linear conductive portion 26c having a line width of w4 will not be arranged in this order in the widthwise direction. Therefore, the lengths of the linear conductive portions 22a-22c and 26a-26c need to be not more than one turn. Meanwhile, if the lengths of the linear conductive portions 22a-22c and 26a-26c are short, there will be more width-changing points. The characteristic impedances of the coil conductors 18 and 20 are likely to change at these width-changing points. For these reasons, the lengths of the linear conductive portions 22a-22c and 26a-26c are preferably not more than one turn and almost one turn. In consideration of this, in the electronic component 10a, the linear conductive portions 22a, 22b and 26b of all the linear conductive portions 22a-22c and 26a-26c have lengths substantially corresponding to one turn.

Since the dielectric layers 16a-16c are made of liquid crystal polymer, the electronic component 10a has an excellent passing characteristic. More specifically, the Q value of a capacitor using liquid crystal polymer as a dielectric is higher than the Q value of a capacitor using polyimide, ceramic or the like as a dielectric. The Q value of a capacitor means the ratio of energy stored in the capacitor to energy scattered and lost during one cycle of an alternating signal applied to the capacitor. Accordingly, having a higher Q value results in a smaller loss. Thus, in the electronic component 10a, since the dielectric layers 16a-16c are made of liquid crystal polymer, the loss of capacitance between the coil conductors 18 and 20 is significantly reduced. Therefore, the passing characteristic of the electronic component 10a is improved.

In the electronic component 10a, since the dielectric layers 16a-16c are made of a flexible material, bending of the multilayer body 12 causes the linear conductive portions 22a-22c to get closer to one another and the linear conductive portions 26a-26c to get closer to one another. Therefore, short circuits are likely to occur among the linear conductive portions 22a-22c and among the linear conductive portions 26a-26c. In order to prevent this trouble, it is preferred to increase the gaps w0 among the linear conductive portions 22a-22c and the gaps w0 among the linear conductive portions 26a-26c. However, increasing the gaps w0 results in an increase in the size of the electronic component 10a.

For this reason, in the electronic component 10a, the relatively wide linear conductive portion 22a, the relatively narrow linear conductive portion 22b and the relatively wide linear conductive portion 22c are arranged in this order in the widthwise direction. That is, relatively wide linear conductive portions and relatively narrow linear conductive portions are arranged alternately in the widthwise direction. Likewise, the relatively narrow linear conductive portion 26a, the relatively wide linear conductive portion 26b and the relatively narrow linear conductive portion 26c are arranged in this order in the widthwise direction. That is, relatively narrow linear conductive portions and relatively wide linear conductive portions are arranged alternately in the widthwise direction. Also, the linear conductive portions 26a-26c are arranged to overlap the linear conductive portions 22a-22c, respectively. As a result, as mentioned above, the electronic component 10a is downsized. Thus, by increasing the gaps w0 to such a degree not to increase the size of the electronic component 10a, both downsizing of the electronic component 10a and prevention of short circuits are achieved.

Further, the linear conductive portions 22a and 22c do not overlap the linear conductive portion 26b in a top-down planar view. Therefore, capacitance is unlikely to be generated between the linear conductive portion 22a and the linear conductive portion 26b and between the linear conductive portion 22c and the linear conductive portion 26b. Accordingly, even if a stacking error occurs during fabrication of the multilayer body 12, as long as the error is smaller than the gap w10, the capacitance between the linear conductive portion 22a and the linear conductive portion 26b and the capacitance between the linear conductive portion 22c and the linear conductive portion 26b hardly change.

In the electronic component 10a, the coil conductors 18 and 20 are spiral. Therefore, in either case in which a stacking error in the front-rear direction occurs or in which a stacking error in the right-left direction occurs, the change in the capacitance between the coil conductors 18 and 20 is significantly reduced or prevented.

### Second Preferred Embodiment

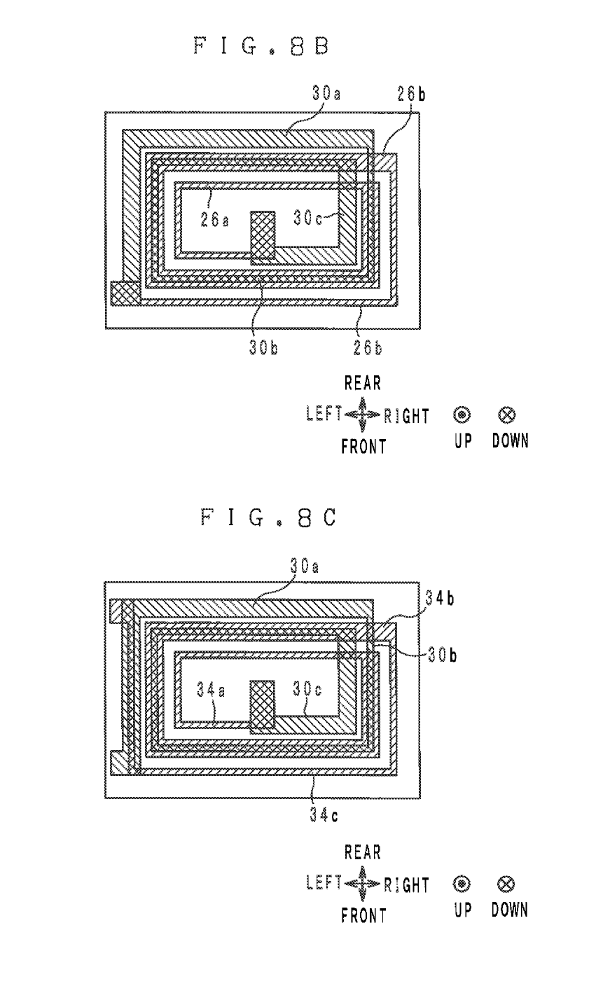

An electronic component according to a second preferred embodiment of the present invention will hereinafter be described with reference to the drawings. FIG. 8A is a perspective view of the electronic component 10b according to the second preferred embodiment. FIG. 8B is a plan view of coil conductors 20 and 19 of the electronic component 10b. FIG. 8C is a plan view of the coil conductor 19 and a coil conductor of the electronic component 10b. The appearance of the electronic component 10b is as illustrated in FIG. 1.

The electronic component 10b differs from the electronic component 10a in that the coil conductors 19 and 21 are further provided. More specifically, the multilayer body 12 of the electronic component 10b includes dielectric layers 16a-16e stacked in this order from the top to the bottom. The coil L of the electronic component 10b includes the coil conductors 18, 20, 19 and 21 connected in series in this order.

The coil conductors 18 and 20 are provided on the front surfaces of the dielectric layers 16b and 16c, respectively. The coil conductors 18 and 20 of the electronic component 10b are the same as the coil conductors 18 and 20 of the electronic component 10a, and descriptions thereof are omitted.

The coil conductor 19 is provided on the front surface of the dielectric layer 16d, and is made of a copper foil, for example. The coil conductor 19 includes linear conductive portions 30a-30c and connection conductive portions 32a and 32b. In a top-down planar view, the coil conductor 19 has a spiral shape spiraling clockwise from the outer circumference toward the center. In the following description, the upstream edge of the clockwise spiral of the coil conductor 19 or each of the linear conductive portions 30a-30c is referred to as an upstream edge, and the downstream edge of the clockwise spiral of the coil conductor 19 or each of the linear conductive portions 30a-30c is referred to as a downstream edge.

The linear conductive portion 30a has a length shorter than one turn and a line width of w5. More specifically, the linear conductive portion 30a extends along the left shorter side and the rear longer side of the dielectric layer 16d. The upstream edge of the linear conductive portion 30a is located near the left front corner of the dielectric layer 16d. The downstream edge of the linear conductive portion 30a is located near the right rear corner of the dielectric layer 16d.

The linear conductive portion 30b has a length substantially corresponding to one turn and a line width of w6. The width w6 is smaller than the width w5. Specifically, the linear conductive portion 30b is arranged at the inner side of the linear conductive portion 30a to define an inner portion of the spiral coil conductor 19 than the linear conductive portion 30a. The linear conductive portion 30b extends along the right shorter side, the front longer side, the left shorter side and the rear longer side of the dielectric layer 16d. Accordingly, the linear conductive portion 30b extends parallel or substantially parallel to the linear conductive portion 30a keeping a constant or substantially constant gap of w0 with the linear conductive portion 30a. The upstream edge and the downstream edge of the linear conductive portion 30b are located near the right rear corner of the dielectric layer 16d. However, the upstream edge of the linear conductive portion 30b and the downstream edge of the linear conductive portion 30b are separate from each other. Also, the upstream edge of the linear conductive portion 30b is connected to the downstream edge of the linear conductive portion 30a.

The linear conductive portion 30c has a length shorter than one turn and a line width of w5. Specifically, the linear conductive portion 30c is arranged at the inner side of the linear conductive portion 30b to define an inner portion of the spiral coil conductor 19 than the linear conductive portion 30b. The linear conductive portion 30c extends along the right shorter side and the right half of the front longer side of the dielectric layer 16d. Accordingly, the linear conductive portion 30c extends parallel or substantially parallel to the linear conductive portion 30b keeping a constant or substantially constant gap of w0 with the linear conductive portion 30b. The upstream edge of the linear conductive portion 30c is located near the right rear corner of the dielectric layer 16d. The downstream edge of the linear conductive portion 30c is located near the center of the dielectric layer 16d. The upstream edge of the linear conductive portion 30c is connected to the downstream edge of the linear conductive portion 30b.

The connection conductive portion 32a is connected to the upstream edge of the linear conductive portion 30a, and is located at the left front corner of the dielectric layer 16d. The connection conductive portion 32b is connected to the downstream edge of the linear conductive portion 30c, and is located in the center (on the intersection point of the diagonal lines) of the dielectric layer 16d.

The coil conductor 21 is provided on the front surface of the dielectric layer 16e, and is made of a copper foil, for example. The coil conductor 21 includes linear conductive portions 34a-34c and connection conductive portions 36a and 36b. In a top-down planar view, the coil conductor 21 has a spiral shape spiraling clockwise from the center toward the outer circumference. In the following description, the upstream edge of the clockwise spiral of the coil conductor 21 or each of the linear conductive portions 34a-34c is referred to as an upstream edge, and the downstream edge of the clockwise spiral of the coil conductor 21 or each of the linear conductive portions 34a-34c is referred to as a downstream edge.

The linear conductive portion 34a has a length shorter than one turn and a line width of w8. Specifically, the linear conductive portion 34a extends along the left half of the front longer side, the left shorter side and the rear longer side of the dielectric layer 16e. The upstream edge of the linear conductive portion 34a is located near the center of the dielectric layer 16e. The downstream edge is located near the right rear corner of the dielectric layer 16e.

The linear conductive portion 34b has a length substantially corresponding to one turn and a line width of w7. The width w8 is smaller than the width w5 and smaller than the width w7. In the second preferred embodiment, the width w7 is equal or substantially equal to the width w1 and the width w5, and the width w8 is equal or substantially equal to the width w2 and the width w6. Specifically, the linear conductive portion 34b is arranged at the outer side of the linear conductive portion 34a to define an outer portion of the spiral coil conductor 21 than the linear conductive portion 34a. The linear conductive portion 34b extends along the right shorter side, the front longer side, the left shorter side and the rear longer side of the dielectric layer 16e. Accordingly, the linear conductive portion 34b extends parallel or substantially parallel to the linear conductive portion 34a keeping a constant or substantially constant gap of w0 with the linear conductive portion 34a. The upstream edge and the downstream edge of the linear conductive portion 34b are located near the right rear corner of the dielectric layer 16e. However, the upstream edge of the linear conductive portion 34b and the downstream edge of the linear conductive portion 34b are separate from each other. The upstream edge of the linear conductive portion 34b is connected to the downstream edge of the linear conductive portion 34a.

The linear conductive portion 34c has a length shorter than one turn and a line width of w8. Specifically, the linear conductive portion 34c is arranged at the outer side of the linear conductive portion 34b to define an outer portion of the spiral coil conductor 21 than the linear conductive portion 34b. The linear conductive portion 34c extends along the right shorter side, the front longer side and the left shorter side of the dielectric layer 16e. Accordingly, the linear conductive portion 34c extends parallel or substantially parallel to the linear conductive portion 34b keeping a constant or substantially constant gap of w0 with the linear conductive portion 34b. The upstream edge of the linear conductive portion 34c is located near the right rear corner of the dielectric layer 16e. The downstream edge of the linear conductive portion 34c is located near the left rear corner of the dielectric layer 16e. The upstream edge of the linear conductive portion 34c is connected to the downstream edge of the linear conductive portion 34b.

The connection conductive portion 36a is connected to the upstream edge of the linear conductive portion 34a, and is located in the center of the dielectric layer 16e. The connection conductive portion 36b is connected to the downstream edge of the linear conductive portion 34c, and is located at the left rear corner of the dielectric layer 16e.

As seen in FIGS. 8A and 8B, in a top-down planar view, the linear conductive portion 30b and the linear conductive portion 26b overlap each other. In a top-down planar view, the linear conductive portion 30b does not protrude from the linear conductive portion 26b in the widthwise direction.

As seen in FIGS. 8A and 8C, in a top-down planar view, the linear conductive portion 30a and the linear conductive portion 34c overlap each other. In a top-down planar view, the linear conductive portion 34c does not protrude from the linear conductive portion 30a in the widthwise direction. As seen in FIGS. 8A and 8C, in a top-down planar view, the linear conductive portion 30b and the linear conductive portion 34b overlap each other. In a top-down planar view, the linear conductive portion 30b does not protrude from the linear conductive portion 34b in the widthwise direction.

A via-hole conductor v5 pierces through the dielectric layer 16c in the up-down direction to connect the connection conductive portion 28b to the connection conductive portion 32a. A via-hole conductor v6 pierces through the dielectric layer 16d in the up-down direction to connect the connection conductive portion 32b to the connection conductive portion 36a. Via-hole conductors v7-v10 pierce through the dielectric layers 16a-16d, respectively, in the up-down direction to define one via-hole conductor. The via-hole conductor v7 is connected to the external electrode 14b, and the via-hole conductor v10 is connected to the connection conductive portion 36b. Accordingly, the coil L is connected between the external electrodes 14a and 14b.

The electronic component 10b having the structure above has the same effects as the electronic component 10a.

### Third Preferred Embodiment

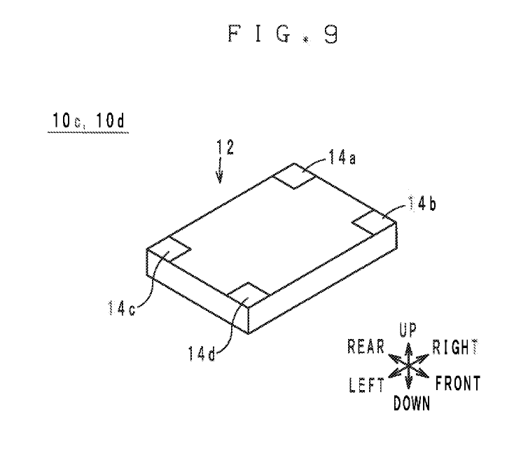

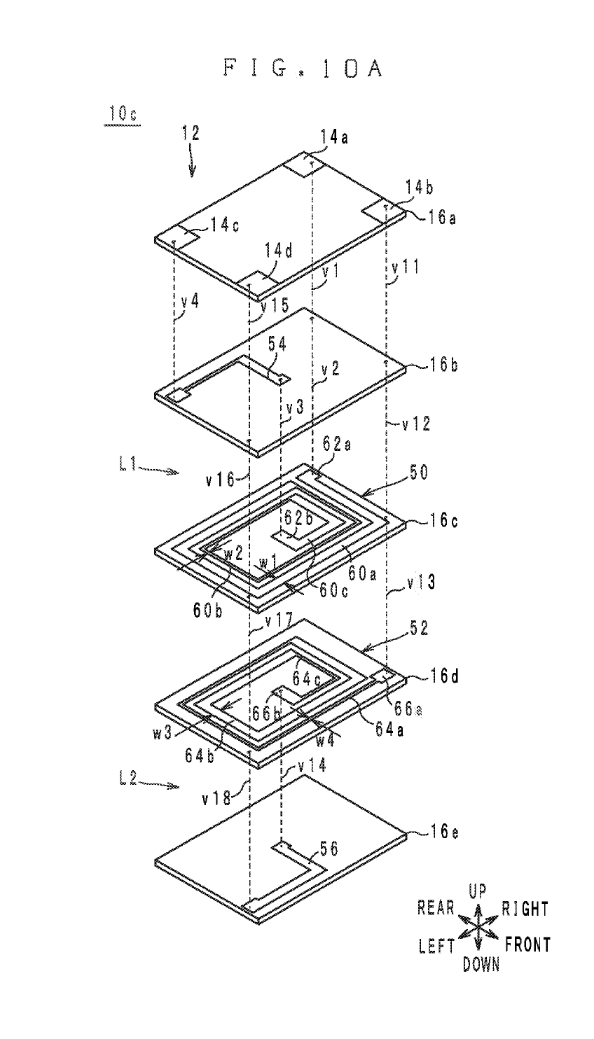

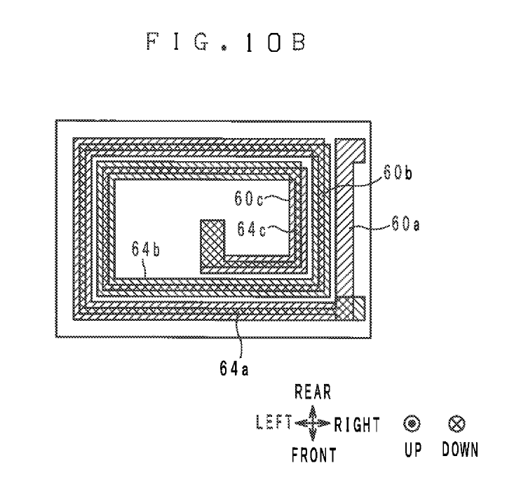

An electronic component according to a third preferred embodiment of the present invention will hereinafter be described with reference to the accompanying drawings. FIG. 9 is a perspective view of the electronic component 10c according to the third preferred embodiment. FIG. 10A is an exploded perspective view of the electronic component 10c according to the third preferred embodiment. FIG. 10B is a plan view of coil conductors 50 and 52 of the electronic component 10c.

The electronic component 10c includes a multilayer body 12, external electrodes 14a-14d, and coils L1 and L2. As seen in FIGS. 9 and 10A, the multilayer body 12 is a rectangular or substantially rectangular plate in a top-down planar view. The multilayer body 12 includes dielectric (insulating) layers 16a-16e stacked in this order from the top to the bottom. The dielectric layers 16a-16e are rectangular or substantially rectangular and are made of a flexible dielectric material, for example, liquid crystal polymer. Since the dielectric layers 16a-16e are flexible, the multilayer body 12 is flexible. In the following description, the upper surface of each of the dielectric layers 16a-16e is referred to as a front surface, and the lower surface of each of the dielectric layers 16a-16e is referred to as a back surface.

The external electrodes 14a-14d are provided on the front surface of the dielectric layer 16a, and the external electrodes 14a-14d are rectangular or substantially rectangular. The external electrode 14a is arranged at the right rear corner of the dielectric layer 16a. The external electrode 14b is arranged at the right front corner of the dielectric layer 16a. The external electrode 14c is arranged at the left rear corner of the dielectric layer 16a. The external electrode 14d is arranged at the left front corner of the dielectric layer 16a. The external electrodes 14a-14d are formed, for example, by plating a copper foil with Ni and Sn.

The coil L1 and the coil L2 are coupled to each other electromagnetically so as to define a common-mode choke coil.

The coil L1 includes a coil conductor 50, a lead conductor 54 and via-hole conductors v1-v4. The coil conductor 50 is provided on the front surface of the dielectric layer 16c and is made of a copper foil, for example. The coil conductor 50 includes linear conductive portions 60a-60c and connection conductive portions 62a and 62b. In a top-down planar view, the coil conductor 50 has a spiral shape spiraling clockwise from the outer circumference toward the center. In the following description, the upstream edge of the clockwise spiral of the coil conductor 50 or each of the linear conductive portions 60a-60c is referred to as an upstream edge, and the downstream edge of the clockwise spiral of the coil conductor 50 or each of the linear conductive portions 60a-60c is referred to as a downstream edge.

The linear conductive portion 60a has a length substantially corresponding to one turn and a line width of w1. Specifically, the linear conductive portion 60a extends along the right shorter side, the front longer side, the left shorter side and the rear longer side of the dielectric layer 16c. The upstream edge and the downstream edge of the linear conductive portion 60a are located near the right rear corner of the dielectric layer 16c. However, the upstream edge of the linear conductive portion 60a and the downstream edge of the linear conductive portion 60b are separate from each other.

The linear conductive portion 60b has a length substantially corresponding to one turn and a line width of w2. The width w2 is smaller than the width w1. Specifically, the linear conductive portion 60b is arranged at the inner side of the linear conductive portion 60a to define an inner portion of the spiral coil conductor 50 than the linear conductive portion 60a. The linear conductive portion 60b extends along the right shorter side, the front longer side, the left shorter side and the rear longer side of the dielectric layer 16c. Accordingly, the linear conductive portion 60b extends parallel or substantially parallel to the linear conductive portion 60a keeping a constant or substantially constant gap of w0 with the linear conductive portion 60a. The upstream edge and the downstream edge of the linear conductive portion 60b are located near the right rear corner of the dielectric layer 16c. However, the upstream edge of the linear conductive portion 60b and the downstream edge of the linear conductive portion 60b are separate from each other. The upstream edge of the linear conductive portion 60b is connected to the downstream edge of the linear conductive portion 60a.

The linear conductive portion 60c has a length shorter than one turn and a line width of w1. Specifically, the linear conductive portion 60c is arranged at the inner side of the linear conductive portion 60b to define an inner portion of the spiral coil conductor 50 than the linear conductive portion 60b. The linear conductive portion 60c extends along the right shorter side and the right half of the front longer side of the dielectric layer 16c. Accordingly, the linear conductive portion 60c extends parallel or substantially parallel to the linear conductive portion 60b keeping a constant or substantially constant gap of w0 with the linear conductive portion 60b. The upstream edge of the linear conductive portion 60c is located near the right rear corner of the dielectric layer 16c. The downstream edge of the linear conductive portion 60c is near the center of the dielectric layer 16c. The upstream edge of the linear conductive portion 60c is connected to the downstream edge of the linear conductive portion 60b.

As described above, the linear conductive portion 60a having a line width of w1, the linear conductive portion 60b having a line width of w2 and the linear conductive portion 60c having a line width of w2 are connected in this order (that is, linear conductive portions having line widths of w1 and linear conductive portions having line widths of w2 are connected alternately), thus defining the coil conductor 50 in a spiral shape. The length of the linear conductive portion 60c is smaller than the length of the linear conductive portion 60b. Therefore, almost the entire length of the linear conductive portion 60c extends along the linear conductive portion 60b. The length of the linear conductive portion 60a is equal or substantially equal to the length of the linear conductive portion 60b and substantially corresponds to one turn. Therefore, almost the entire length of the linear conductive portion 60a extends along the linear conductive portion 60b. Accordingly, in the coil conductor 50, the linear conductive portion 60a having a line width of w1, the linear conductive portion 60b having a line width of w2 and the linear conductive portion 60c having a line width of w1 are arranged in this order from the outer circumference toward the center. In other words, in the coil conductor 50, linear conductive portions having line widths of w1 and linear conductive portions having line widths of w2 are arranged alternately in the widthwise direction with uniform or substantially uniform gaps of w0 therebetween. The widthwise direction is a direction perpendicular or substantially perpendicular to the extending direction of the linear conductive portions 60a-60c.

The connection conductive portion 62a is connected to the upstream edge of the linear conductive portion 60a and is located at the rear right corner of the dielectric layer 16c. The connection conductive portion 62b is connected to the downstream edge of the linear conductive portion 60c and is located in the center (on the intersection point of the diagonal lines) of the dielectric layer 16c.

The lead conductor 54 is a linear conductor provided on the front surface of the dielectric layer 16b and made of a copper foil, for example. An end of the lead conductor 54 overlaps the connection conductive portion 62b in a top-down planar view. The other end of the lead conductor 54 overlaps the external electrode 14c in a top-down planar view.

The via-hole conductors v1 and v2 pierce through the dielectric layers 16a and 16b, respectively, in the up-down direction to define one via-hole conductor. The via-hole conductor v1 is connected to the external electrode 14a, and the via-hole conductor v2 is connected to the connection conductive portion 62a. The via-hole conductor v3 pierces through the dielectric layer 16b in the up-down direction to connect the connection conductive portion 62b to one end of the lead conductor 54. The via-hole conductor v4 pierces through the dielectric layer 16a in the up-down direction to connect the other end of the lead conductor 54 to the external electrode 14c. Accordingly, the coil L1 is connected between the external electrodes 14a and 14c.

The coil L2 includes a coil conductor 52, a lead conductor 56 and via-hole conductors v11-v18. The coil conductor 52 is provided on the front surface of the dielectric layer 16d and is made of a copper foil, for example. The coil conductor 52 includes linear conductive portions 64a-64c and connection conductive portions 66a and 66b. In a top-down planar view, the coil conductor has a spiral shape spiraling clockwise from the outer circumference toward the center. In the following description, the upstream edge of the clockwise spiral of the coil conductor 52 or each of the linear conductive portions 64a-64c is referred to as an upstream edge, and the downstream edge of the clockwise spiral of the coil conductor 52 or each of the linear conductive portions 64a-64c is referred to as a downstream edge.

The linear conductive portion 64a has a length shorter than one turn and a line width of w4. Specifically, the linear conductive portion 64a extends along the front longer side, the left shorter side and the rear longer side of the dielectric layer 16d. The upstream edge of the linear conductive portion 64a is located near the right front corner of the dielectric layer 16d. The downstream edge of the linear conductive portion 64a is located near the right rear corner of the dielectric layer 16d.

The linear conductive portion 64b has a length substantially corresponding to one turn and a line width of w3. The width w4 is smaller than the width w3. Specifically, the linear conductive portion 64b is arranged at the inner side of the linear conductive portion 64a to define an inner portion of the spiral coil conductor 52 than the linear conductive portion 64a. The linear conductive portion 64b extends along the right shorter side, the front longer side, the left shorter side and the rear longer side of the dielectric layer 16d. Accordingly, the linear conductive portion 64b extends parallel or substantially parallel to the linear conductive portion 64a keeping a constant or substantially constant gap of w0 with the linear conductive portion 64a. The upstream edge and the downstream edge of the linear conductive portion 64b are located near the right rear corner of the dielectric layer 16d. However, the upstream edge of the linear conductive portion 64b and the downstream edge of the linear conductive portion 64b are separate from each other. The upstream edge of the linear conductive portion 64b is connected to the downstream edge of the linear conductive portion 64a.

The linear conductive portion 64c has a length shorter than one turn and a line width of w4. Specifically, the linear conductive portion 64c is arranged at the inner side of the linear conductive portion 64b to define an inner portion of the spiral coil conductor 52 than the linear conductive portion 64b. The linear conductive portion 64c extends along the right shorter side and the right half of the front longer side of the dielectric layer 16d. Accordingly, the linear conductive portion 64c extends parallel or substantially parallel to the linear conductive portion 64b keeping a constant or substantially constant gap of w0 with the linear conductive portion 64b. The upstream edge of the linear conductive portion 64c is located near the right rear corner of the dielectric layer 16d. The downstream edge of the linear conductive portion 64c is near the center of the dielectric layer 16d. The upstream edge of the linear conductive portion 64c is connected to the downstream edge of the linear conductive portion 64b.

As described above, the linear conductive portion 64a having a line width of w4, the linear conductive portion 64b having a line width of w3 and the linear conductive portion 64c having a line width of w4 are connected in this order (that is, linear conductive portions having line widths of w4 and linear conductive portions having line widths of w3 are connected alternately), thus defining conductor 52 in a spiral shape. The length of the linear conductive portion 64c is smaller than the length of the linear conductive portion 64b. Therefore, almost the entire length of the linear conductive portion 64c extends along the linear conductive portion 64b. The length of the linear conductive portion 64a is smaller than the length of the linear conductive portion 64b. Therefore, almost the entire length of the linear conductive portion 64a extends along the linear conductive portion 64b. Accordingly, in the coil conductor 52, the linear conductive portion 64a having a line width of w4, the linear conductive portion 64b having a line width of w3 and the linear conductive portion 64c having a line width of w4 are arranged in this order from the outer circumference toward the center. In other words, in the coil conductor 52, linear conductive portions having line widths of w4 and linear conductive portions having line widths of w3 are arranged alternately in the widthwise direction with uniform or substantially uniform gaps of w0 therebetween. The widthwise direction is a direction perpendicular or substantially perpendicular to the extending direction of the linear conductive portions 64a-64c.

The connection conductive portion 66a is connected to the upstream edge of the linear conductive portion 64a and is located at the right front corner of the dielectric layer 16d. The connection conductive portion 66b is connected to the downstream edge of the linear conductive portion 64c and is located in the center (on the intersection point of the diagonal lines) of the dielectric layer 16d.

The lead conductor 56 is a linear conductor provided on the front surface of the dielectric layer 16e and made of a copper foil, for example. An end of the lead conductor 56 overlaps the connection conductive portion 66b in a top-down planar view. The other end of the lead conductor 54 overlaps the external electrode 14d in a top-down planar view.

As seen in FIG. 10B, in a top-down planar view, the linear conductive portion 60a and the linear conductive portion 64a overlap each other. In a top-down planar view, the linear conductive portion 64a does not protrude from the linear conductive portion 60a in the widthwise direction. As seen in FIG. 10B, in a top-down planar view, the linear conductive portion 60b and the linear conductive portion 64b overlap each other. In a top-down planar view, the linear conductive portion 60b does not protrude from the linear conductive portion 64b in the widthwise direction. As seen in FIG. 10B, in a top-down planar view, the linear conductive portion 60c and the linear conductive portion 64c overlap each other. In a top-down planar view, the linear conductive portion 64c does not protrude from the linear conductive portion 60c in the widthwise direction.

The via-hole conductors v11-v13 pierce through the dielectric layers 16a-16c, respectively, in the up-down direction to define one via-hole conductor. The via-hole conductor v11 is connected to the external electrode 14b, and the via-hole conductor v13 is connected to the connection conductive portion 66a. The via-hole conductor v14 pierces through the dielectric layer 16d in the up-down direction to connect the connection conductive portion 66b to one end of the lead conductor 56. The via-hole conductors v15-v18 pierce through the dielectric layers 16a-16d, respectively, in the up-down direction to define one via-hole conductor. The via-hole conductor v15 is connected to the external electrode 14d, and the via-hole conductor v18 is connected to the other end of the lead conductor 56. Accordingly, the coil L2 is connected between the external electrodes 14b and 14d.

In the electronic component 10c having the structure above, the coils L1 and L2 are arranged to overlap each other in a top-down planar view. Therefore, magnetic fluxes generated from the coil L1 pass through the coil L2, and magnetic fluxes generated from the coil L2 pass through the coil L1. Accordingly, the coil L1 and the coil L2 are coupled to each other electromagnetically, and the coil L1 and the coil L2 define a common-mode choke coil. The external electrodes 14a and 14b are used as input terminals, and the external electrodes 14c and 14d are used as output terminals. Thus, differential transmission signals are input through the external electrodes 14a and 14b and output through the external electrodes 14c and 14d. If the differential transmission signals include common-mode noise, the common-mode noise will cause the coil L1 and the coil L2 to generate magnetic fluxes in the same direction. Therefore, the magnetic fluxes are enhanced by one another, thus generating impedance to the common-mode noise. Consequently, the common-mode noise is converted into heat. In this way, the electronic component 10c prevents common-monde noise from passing through the coils L1 and L2.

The electronic component 10c having the structure above has the same effects as the electronic component 10a.

In the electronic component 10c, the coil L1 and the coil L2 define a common-mode choke coil. In the electronic component 10c, the risk of a change in the capacitance between the coil conductor 50 and the coil conductor 52 is reduced, and therefore, the risk of a change in the coupling strength between the coil L1 and the coil L2 is reduced.

### Fourth Preferred Embodiment

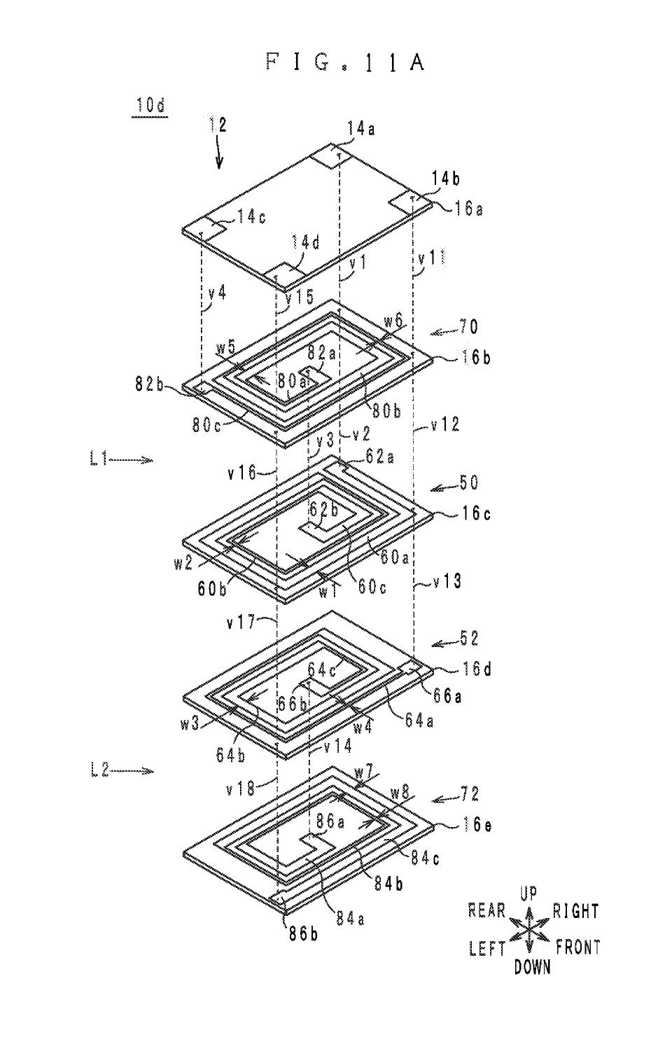

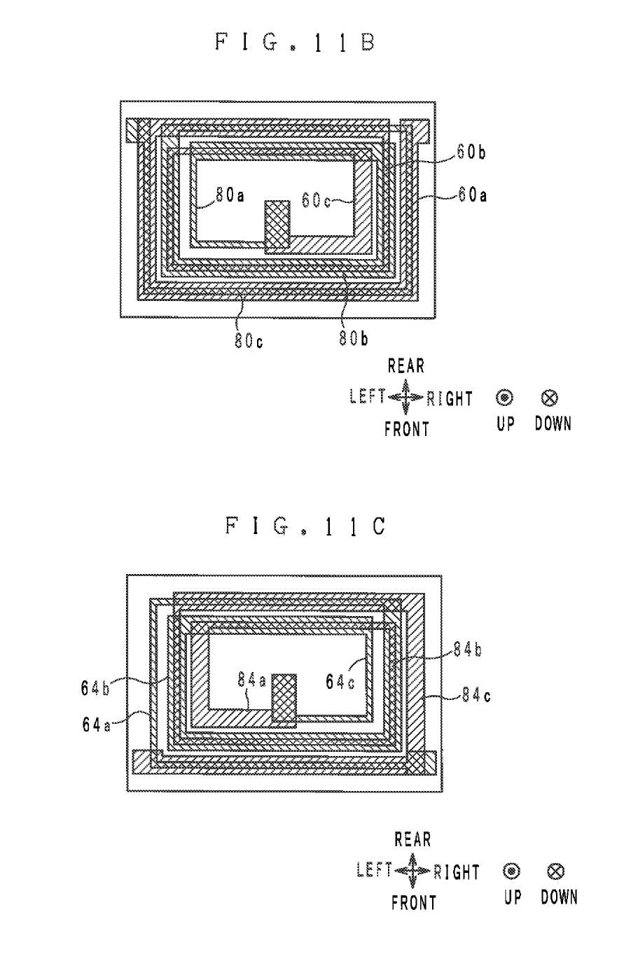

An electronic component according to a fourth preferred embodiment of the present invention will hereinafter be described with reference to the drawings. FIG. 11A is an exploded perspective view of the electronic component 10d according to the fourth preferred embodiment. FIG. 11B is a plan view of coil conductors 50 and 70 of the electronic component 10d. FIG. 11C is a plan view of coil conductors 52 and 72 of the electronic component 10d. The appearance of the electronic component 10d is as illustrated in FIG. 9.

The electronic component 10d differs from the electronic component 10c in that the coil conductor 70 is provided instead of the lead conductor 54 and in that the coil conductor 72 is provided instead of the lead conductor 56.

The coil conductor 70 is provided on the front surface of the dielectric layer 16b and is made of a copper foil, for example. The coil conductor 70 includes linear conductive portions 80a-80c, and connection conductive portions 82a and 82b. In a top-down planar view, the coil conductor 70 has a spiral shape spiraling clockwise from the center toward the outer circumference. The upstream edge of the clockwise spiral of the coil conductor 70 or each of the linear conductive portions 80a-80c is referred to as an upstream edge, and the downstream edge of the clockwise spiral of the coil conductor 70 or each of the linear conductive portions 80a-80c is referred to as a downstream edge.

The linear conductive portion 80a has a length shorter than one turn and a line width of w6. Specifically, the linear conductive portion 80a extends along the left half of the front longer side and the left shorter side of the dielectric layer 16b. The upstream edge of the linear conductive portion 80a is located near the center of the dielectric layer 16b. The downstream edge of the linear conductive portion 80a is located at the left rear corner of the dielectric layer 16b.

The linear conductive portion 80b has a length substantially corresponding to one turn and a line width of w5. The width w6 is smaller than the width w5. In this preferred embodiment, the width w5 is equal or substantially equal to the width w1, and the width w6 is equal or substantially equal to the width w2. Specifically, the linear conductive portion 80b is arranged at the outer side of the linear conductive portion 80a to define an outer portion of the coil conductor 70 than the linear conductive portion 80a. The linear conductive portion 80b extends along the rear longer side, the right shorter side, the front longer side and the left shorter side of the dielectric layer 16b. Accordingly, the linear conductive portion 80b extends parallel or substantially parallel to the linear conductive portion 80a keeping a constant or substantially constant gap of w0 with the linear conductive portion 80a. The upstream edge and the downstream edge of the linear conductive portion 80b are located near the right rear corner of the dielectric layer 16b. However, the upstream edge of the linear conductive portion 80b and the downstream edge of the linear conductive portion 80b are separate from each other. The upstream edge of the linear conductive portion 80b is connected to the downstream edge of the linear conductive portion 80a.

The linear conductive portion 80c has a length substantially corresponding to one turn and a line width of w6. Specifically, the linear conductive portion 80c is arranged at the outer side of the linear conductive portion 80b to define an outer portion of the coil conductor 70 than the linear conductive portion 80b. The linear conductive portion 80b extends along the rear longer side, the right shorter side, the front longer side and the left shorter side of the dielectric layer 16b. Accordingly, the linear conductive portion 80c extends parallel or substantially parallel to the linear conductive portion 80b keeping a constant or substantially constant gap of w0 with the linear conductive portion 80b. The upstream edge and the downstream edge of the linear conductive portion 80c are located near the left rear corner of the dielectric layer 16b. However, the upstream edge of the linear conductive portion 80c and the downstream edge of the linear conductive portion 80c are separate from each other. The upstream edge of the linear conductive portion 80c is connected to the downstream edge of the linear conductive portion 80b.

The connection conductive portion 82a is connected to the upstream edge of the linear conductive portion 80a and is located in the center of the dielectric layer 16b. The connection conductive portion 82b is connected to the downstream edge of the linear conductive portion 80c and is located at the left rear corner of the dielectric layer 16b.

As seen in FIGS. 11A and 11B, in a top-down planar view, the linear conductive portion 80b and the linear conductive portion 60b overlap each other. In a top-down planar view, the linear conductive portion 60b does not protrude from the linear conductive portion 80b in the widthwise direction. As seen in FIGS. 11A and 11B, in a top-down planar view, the linear conductive portion 80c and the linear conductive portion 60a overlap each other. In a top-down planar view, the linear conductive portion 80c does not protrude from the linear conductive portion 60a in the widthwise direction.

The via-hole conductor v3 connects the connection conductive portion 82a to the connection conductive portion 62a. The via-hole conductor v4 connects the external electrode 14c to the connection conductive portion 82c. Accordingly, the coil L1 is connected between the external electrodes 14a and 14c.

The coil conductor 72 is provided on the front surface of the dielectric layer 16f and is made of a copper foil, for example. The coil conductor 72 includes linear conductive portions 84a-84c, and connection conductive portions 86a and 86b. In a top-down planar view, the coil conductor 72 spirals clockwise from the center toward the outer circumference. The upstream edge of the clockwise spiral of the coil conductor 72 or each of the linear conductive portions 86a-86c is referred to as an upstream edge, and the downstream edge of the clockwise spiral of the coil conductor 72 or each of the linear conductive portions 86a-86c is referred to as a downstream edge.

The linear conductive portion 84a has a length shorter than one turn and a line width of w7. Specifically, the linear conductive portion 84a extends along the front longer side and the left shorter side of the dielectric layer 16f. The upstream edge of the linear conductive portion 84a is located near the center of the dielectric layer 16f. The downstream edge of the linear conductive portion 84a is located near the left rear corner of the dielectric layer 16f.

The linear conductive portion 84b has a length substantially corresponding to one turn and a line width of w8. The width w8 is smaller than the width w7. In this preferred embodiment, the width w7 is equal or substantially equal to the widths w1 and w5, and the width w8 is equal or substantially equal to the widths w2 and w6. Specifically, the linear conductive portion 84b is arranged at the outer side of the linear conductive portion 84a to define an outer portion of the coil conductor 72 than the linear conductive portion 84a. The linear conductive portion 84b extends along the rear longer side, the right shorter side, the front longer side and the left shorter side of the dielectric layer 16f. Accordingly, the linear conductive portion 84b extends parallel or substantially parallel to the linear conductive portion 84a keeping a constant or substantially constant gap of w0 with the linear conductive portion 84a. The upstream edge and the downstream edge of the linear conductive portion 84b are located near the left rear corner of the dielectric layer 16f. However, the upstream edge of the linear conductive portion 84b and the downstream edge of the linear conductive portion 84b are separate from each other. The upstream edge of the linear conductive portion 84b is connected to the downstream edge of the linear conductive portion 84a.

The linear conductive portion 84c has a length shorter than one turn and a line width of w7. Specifically, the linear conductive portion 84c is arranged at the outer side of the linear conductive portion 84b to define an outer portion of the coil conductor 72 than the linear conductive portion 84b. The linear conductive portion 84b extends along the rear longer side, the right shorter side and the front longer side of the dielectric layer 16f. Accordingly, the linear conductive portion 84c extends parallel or substantially parallel to the linear conductive portion 84b keeping a constant or substantially constant gap of w0 with the linear conductive portion 84b. The upstream edge of the linear conductive portion 84c is located near the left rear corner of the dielectric layer 16f. The downstream edge of the linear conductive portion 84c is located near the left front corner of the dielectric layer 16f. The upstream edge of the linear conductive portion 84c is connected to the downstream edge of the linear conductive portion 84b.

The connection conductive portion 86a is connected to the upstream edge of the linear conductive portion 84a and is located in the center of the dielectric layer 16f. The connection conductive portion 86b is connected to the downstream edge of the linear conductive portion 84c and is located at the left front corner of the dielectric layer 16f.

As seen in FIGS. 11A and 11C, in a top-down planar view, the linear conductive portion 84b and the linear conductive portion 64b overlap each other. In a top-down planar view, the linear conductive portion 84b does not protrude from the linear conductive portion 64b in the widthwise direction. As seen in FIGS. 11A and 11C, in a top-down planar view, the linear conductive portion 84c and the linear conductive portion 64a overlap each other. In a top-down planar view, the linear conductive portion 64a does not protrude from the linear conductive portion 84c in the widthwise direction.

The via-hole conductor v14 connects the connection conductive portion 66b to the connection conductive portion 86a. The via-hole conductor v18 is connected to the connection conductive portion 86b. Accordingly, the coil L2 is connected between the external electrodes 14b and 14d.

The electronic component 10d having the structure above has the same effects as the electronic component 10a.

In the electronic component 10d, the coil L1 and the coil L2 define a common-mode choke coil. In the electronic component 10d, the risk of a change in the capacitance between the coil conductor 50 and the coil conductor 52 is reduced, and therefore, the risk of a change in the coupling strength between the coil L1 and the coil L2 is reduced.

### Fifth Preferred Embodiment

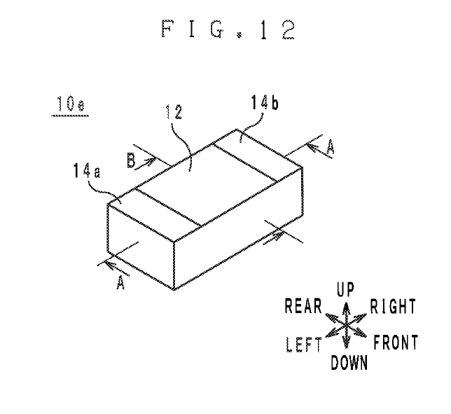

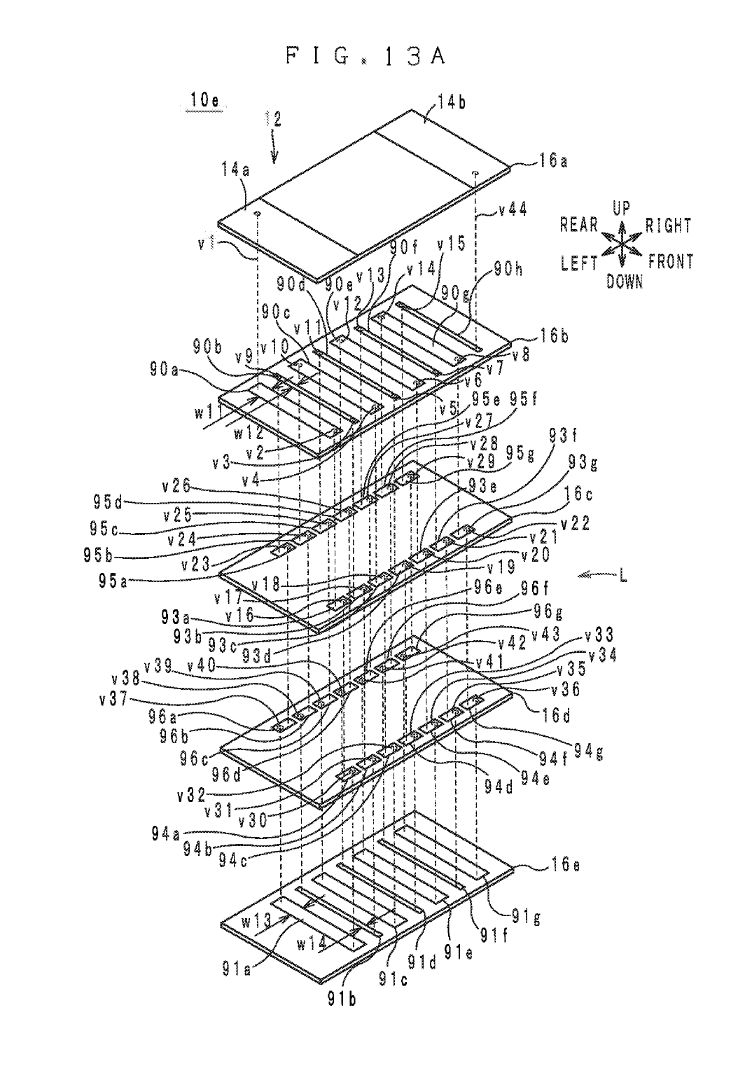

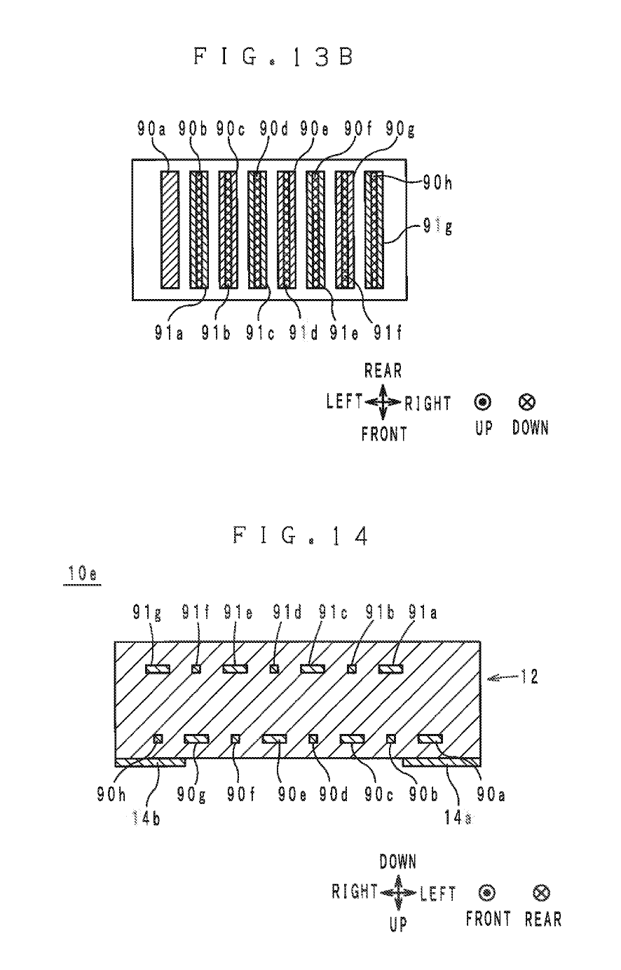

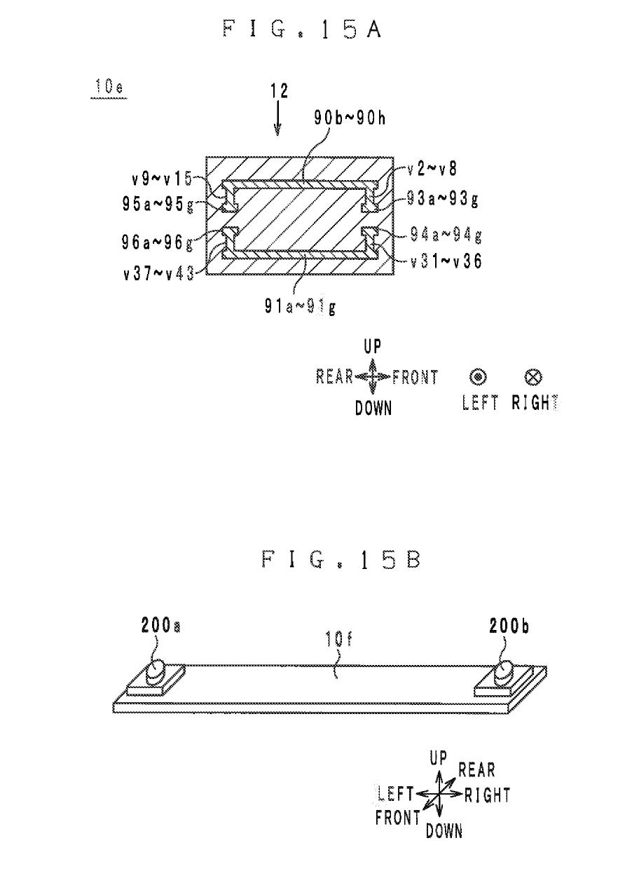

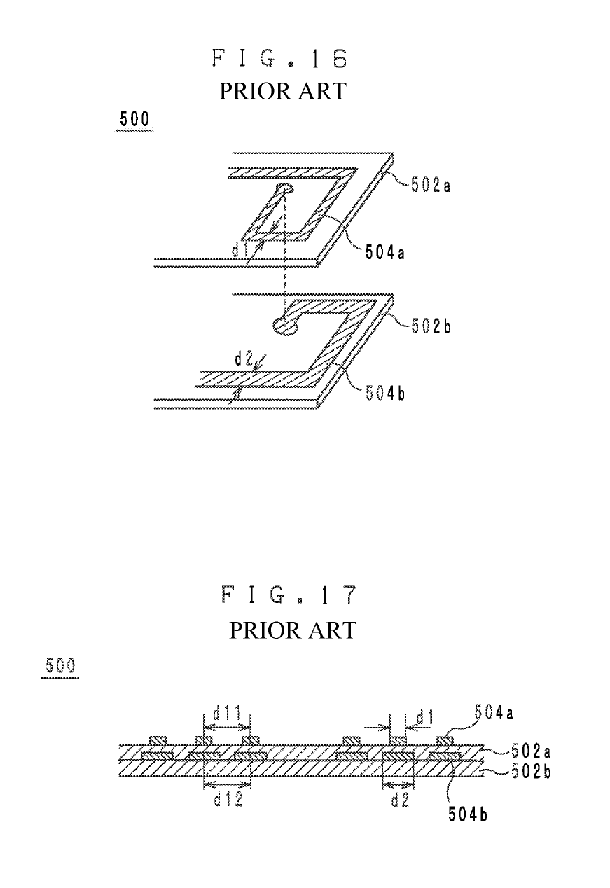

An electronic component according to a fifth preferred embodiment of the present invention will hereinafter be described with reference to the drawings. FIG. 12 is a perspective view of the electronic component 10e according to the fifth preferred embodiment. FIG. 13A is an exploded perspective view of the electronic component 10e according to the fifth preferred embodiment. FIG. 13B is a plan view of linear conductors 90a-90h and 91a-91g of the electronic component 10e. FIG. 14 is a sectional view of the electronic component 10e cut along the line A-A. FIG. 15A is a sectional view of the electronic component 10e cut along the line B-B. In the following description, the layer stacking direction of the electronic component 10e is referred to as an up-down direction. In a top-down planar view, the direction in which longer sides of the electronic component 10e extends is referred to as a right-left direction, and the direction in which shorter sides of the electronic component 10e extends is referred to as a front-rear direction.

The electronic component 10e includes a multilayer body 12, external electrodes 14a and 14b, and a coil L. As illustrated in FIGS. 12 and 13A, the multilayer body 12 is a rectangular or substantially rectangular plate in a top-down planar view, and includes dielectric layers (insulating layers) 16a-16e stacked in this order from the top to the bottom. The dielectric layers 16a-16e are rectangular or substantially rectangular and are made of a dielectric material, for example, liquid crystal polymer. The dielectric layers 16a-16e are flexible, and accordingly, the multilayer body 12 is flexible. In the following description, the upper surface of each of the dielectric layers 16a-16e is referred to as a front surface, and the lower surface of each of the dielectric layers 16a-16e is referred to as a back surface.

The external electrodes 14a and 14b are provided on the front surface of the dielectric layer 16a, and each of the external electrodes 14a and 14b has a rectangular or substantially rectangular shape that is long in the front-rear direction. The external electrode 14a is arranged along the left shorter side of the dielectric layer 16a, and the external electrode 14b is arranged along the right shorter side of the dielectric layer 16a. Each of the external electrodes 14a and 14b is formed, for example, by plating a copper foil with Ni and Sn.

The coil L includes linear conductors 90a-90h and 91a-91g, connection conductors 93a-93g, 94a-94g, 95a-95g and 96a-96g, and via-hole conductors v1-v44.

The linear conductors 90a-90h are provided on the front surface of the dielectric layers 16b and are arranged in this order from the left side to the right side with uniform or substantially uniform gaps therebetween. The linear conductors 90a-90h are made of a copper foil, for example. The linear conductors 90a, 90c, 90e and 90g extend in the front-rear direction and have line widths of w11. The linear conductors 90b, 90d, 90f and 90h extend in the front-rear direction and have line widths of w12. The width w12 is smaller than the width w11. Accordingly, linear conductors having line widths of w11 (the linear conductors 90a, 90c, 90e and 90g) and linear conductors having line widths of w12 (the linear conductors 90b, 90d, 90f and 90h) are arranged alternately in the right-left direction (the widthwise direction of the linear conductors). In the following description, the edge in the front of each of the linear conductors 90a-90h is referred to as a front edge, and the edge in the rear of each of the linear conductors 90a-90h is referred to as a rear edge.

The linear conductors 91a-91g are provided on the front surface of the dielectric layers 16e and are arranged in this order from the left side to the right side with uniform or substantially uniform gaps therebetween. The linear conductors 91a-91g are made of a copper foil, for example. The linear conductors 91a, 91c, 91e and 91g extend in the front-rear direction and have line widths of w13. The linear conductors 91b, 91d and 91f extend in the front-rear direction and have line widths of w14. The width w14 is smaller than the width w13. Accordingly, linear conductors having line widths of w13 (the linear conductors 91a, 91c, 91e and 91g) and linear conductors having line widths of w14 (the linear conductors 91b, 91d and 91f) are arranged alternately in the right-left direction. In the following description, the edge in the front of each of the linear conductors 91a-91g is referred to as a front edge, and the edge in the rear of each of the linear conductors 91a-91g is referred to as a rear edge.

The linear conductors 90a-90h and 91a-91g are substantially of the same length (the same dimension in the front-rear direction).

As seen in FIGS. 13B and 14, in a top-down planar view, the linear conductors 90c, 90e and 90g overlap the linear conductors 91b, 91d and 91f, respectively. In a top-down planar view, the linear conductors 91b, 91d and 91f do not protrude from the linear conductors 90c, 90e and 90g, respectively, in the widthwise direction.

As seen in FIGS. 13B and 14, in a top-down planar view, the linear conductors 90b, 90d, 90f and 90h overlap the linear conductors 91a, 91c, 91e and 91g, respectively. In a top-down planar view, the linear conductors 90b, 90d, 90f and 90h do not protrude from the linear conductors 91a, 91c, 91e and 91g, respectively, in the widthwise direction.

The via-hole conductor v1 pierces through the dielectric layer 16a in the up-down direction to connect the external electrode 14a to the rear edge of the connection conductor 90a. The via-hole conductor v44 pierces through the dielectric layer 16a in the up-down direction to connect the external electrode 14b to the front edge of the connection conductor 90h.

The front edges of the linear conductors 90a, 90c, 90e and 90g are electrically connected to the front edges of the linear conductors 91a, 91c, 91e and 91g, respectively, which are arranged respectively at the immediate right side (respectively at one side in the widthwise direction) of the linear conductors 90a, 90c, 90e and 90g in a top-down planar view. Also, the front edges of the linear conductors 90b, 90d and 90f are electrically connected to the front edges of the linear conductors 91b, 91d and 91f, respectively, which are arranged respectively at the immediate right side (respectively at one side in the widthwise direction) of the linear conductors 90b, 90d and 90f in a top-down planar view.

The rear edges of the linear conductors 90c, 90e and 90g are electrically connected to the rear edges of the linear conductors 91b, 91d and 91f, respectively, which overlap the linear conductors 90c, 90e and 90g, respectively, in a top-down planar view. Also, the rear edges of the linear conductors 90b, 90d, 90f and 90h are electrically connected to the rear edges of the linear conductors 91a, 91c, 91e and 91g, respectively, which overlap the linear conductors 90b, 90d, 90f and 90h, respectively, in a top-down planar view. A detailed description will be given below.

The connection conductors 93a-93g are provided on the front surface of the dielectric layer 16c, and are rectangular or substantially rectangular. The connection conductors 93a-93g are arranged in this order from the left side to the right side along the front longer side of the dielectric layer 16c. In a top-down plan view, the left edges of the connection conductors 93a-93g overlap the front edges of the linear conductors 90a-90g, respectively.

The connection conductors 94a-94g are provided on the front surface of the dielectric layer 16d, and are rectangular or substantially rectangular. The connection conductors 94a-94g are arranged in this order from the left side to the right side along the front longer side of the dielectric layer 16d. In a top-down planar view, the left edges of the connection conductors 94a-94g overlap the right edges of the connection conductors 93a-93g, respectively. Also, in a top-down plan view, the right edges of the connection conductors 94a-94g overlap the front edges of the linear conductors 91a-91g, respectively.

The via-hole conductors v2-v8 pierce through the dielectric layer 16b in the up-down direction to connect the front edges of the linear conductors 90a-90g to the left edges of the connection conductors 93a-93g, respectively. The via-hole conductors v16-v22 pierce through the dielectric layer 16c in the up-down direction to connect the right edges of the connection conductors 93a-93g to the left edges of the connection conductors 94a-94g, respectively. The via-hole conductors v30-v36 pierce through the dielectric layer 16d in the up-down direction to connect the right edges of the connection conductors 94a-94g to the front edges of the linear conductors 91a-91g, respectively. Thus, as seen in FIGS. 13A-15A, the via-hole conductors v2-v8, v16-v22 and v30-v36 are not connected straight in the up-down direction.

The connection conductors 95a-95g are provided on the front surface of the dielectric layer 16c, and are rectangular or substantially rectangular. The connection conductors 95a-95g are arranged in this order from the left side to the right side along the rear longer side of the dielectric layer 16c. In a top-down plan view, the left edges of the connection conductors 95a-95g overlap the rear edges of the linear conductors 90b-90h, respectively.

The connection conductors 96a-96g are provided on the front surface of the dielectric layer 16d, and are rectangular or substantially rectangular. The connection conductors 96a-96g are arranged in this order from the left side to the right side along the rear longer side of the dielectric layer 16d. In a top-down plan view, the connection conductors 96a-96g overlap the connection conductors 95a-95g. Also, in a top-down plan view, the left edges of the connection conductors 96a-96g overlap the rear edges of the linear conductors 91a-91g, respectively.

The via-hole conductors v9-v15 pierce through the dielectric layer 16b in the up-down direction to connect the rear edges of the linear conductors 90b-90h to the left edges of the connection conductors 95a-95g, respectively. The via-hole conductors v23-v29 pierce through the dielectric layer 16c in the up-down direction to connect the right edges of the connection conductors 95a-95g to the right edges of the connection conductors 96a-96g, respectively. The via-hole conductors v37-v43 pierce through the dielectric layer 16d in the up-down direction to connect the left edges of the connection conductors 96a-96g to the rear edges of the linear conductors 91a-91g, respectively. Thus, as seen in FIGS. 13A-15A, the via-hole conductors v9-v15, v23-v29 and v37-v43 are not connected straight in the up-down direction.

The coil L having the structure above has a spiral shape spiraling clockwise from the left side to the right side.

The electronic component 10e having the structure above has the same effects as the electronic component 10a.

Additionally, in the electronic component 10e, the risk of breakage of the via-hole conductors v2-v43 is significantly reduced or eliminated. This will hereinafter be described with the connection conductors 93a, 94a and the via-hole conductors v2, v16 and v30 taken as an example.

At a step of pressure-bonding the multilayer body, the dielectric layers and the via-hole conductors are heated. In this regard, the amounts of expansion and contraction of the via-hole conductors, which are made of a conductive material, with changes in temperature are greater than the amounts of expansion and contraction of the dielectric layers, which are made of thermoplastic resin, with changes in temperature. Accordingly, at the pressure-bonding step, the amount of expansion in the up-down direction of each via-hole conductor is greater than the amount of expansion in the up-down direction of each dielectric layer. Consequently, in the pressure-bonding step, forces are applied concentrically to each via-hole conductor from above and from underneath. Under the circumstances, if the via-hole conductors are connected straight in the up-down direction, there is a risk of breakage of the via-hole conductors due to the forces applied from above and underneath.

In the electronic component 10e, the via-hole conductor v2 and the via-hole conductor v16 are not connected straight. Specifically, in a top-down planar view, the lower end of the via-hole conductor v2 that contacts with the connection conductor 93a from above does not overlap the upper end of the via-hole conductor v16 that contacts with the connection conductor 93a from underneath. Therefore, even if a force is applied to the via-hole conductor v2 from above at the pressure-bonding step, the force is not directly transmitted from the via-hole conductor v2 to the via-hole conductor v16. Likewise, even if a force is applied to the via-hole conductor v16 from underneath at the pressure-bonding step, the force is not directly transmitted from the via-hole conductor v16 to the via-hole conductor v2. Thus, applications of great forces to the via-hole conductors v2 and v16 from above and from underneath are prevented. Consequently, the risk of breakage of the via-hole conductors v2 and v16 is significantly reduced or eliminated.

The via-hole conductor v16 and the via-hole conductor v30 are not connected straight. Specifically, in a top-down planar view, the lower end of the via-hole conductor v16 that contacts with the connection conductor 94a from above does not overlap the upper end of the via-hole conductor v30 that contacts with the connection conductor 94a from underneath. Therefore, even if a force is applied to the via-hole conductor v16 from above at the pressure-bonding step, the force is not directly transmitted from the via-hole conductor v16 to the via-hole conductor v30. Likewise, even if a force is applied to the via-hole conductor v30 from underneath at the pressure-bonding step, the force is not directly transmitted from the via-hole conductor v30 to the via-hole conductor v16. Thus, applications of great forces to the via-hole conductors v16 and v30 from above and from underneath are prevented. Consequently, the risk of breakage of the via-hole conductors v16 and v30 is significantly reduced or eliminated.

The linear conductors 90a-90h and the linear conductors 91a-91g extend in the same direction. Therefore, in the coil L, the direction of magnetic field generated by the linear conductors 90a-90h and the direction of magnetic field generated by the linear conductors 91-91g are the same. This results in a large inductance value of the coil L and an improved Q value of the coil L.

In the electronic component 10e, further, the risk of delamination of the multilayer body 12 is reduced. A detailed description will be hereinafter given with the via-hole conductors v2, v16 and v30 taken as an example.

In the electronic component 10e, in a top-down planar view, the lower end of the via-hole conductor v2 that contacts with the connection conductor 93a from above does not overlap the upper end of the via-hole conductor v16 that contacts with the connection conductor 93a from underneath. Likewise, in a top-down planar view, the lower end of the via-hole conductor v16 that contacts with the connection conductor 94a from above does not overlap the upper end of the via-hole conductor v30 that contacts with the connection conductor 94a from underneath. Accordingly, the via-hole conductors v2, v16 and v30 are not connected straight. Therefore, at the pressure-bonding step, there is almost no risk that expansion of the via-hole conductors v2, v16 and v30 by heat causes the via-hole conductors v2, v16 and v30 to protrude significantly from the dielectric layers 16b-16d. Consequently, the risk of delamination between the dielectric layers 16a and 16b around the via-hole conductor v2 and the risk of delamination between the dielectric layers 16d and 16e around the via-hole conductor v30 can be reduced. Thus, the risk of delamination of the multilayer body 12 is significantly reduced or eliminated.

Since there is almost no risk of significant protrusions of the via-hole conductors v2, v16 and v30 from the dielectric layers 16b-16d, there is almost no risk that the via-hole conductors v2 and v30 pierce and break the linear conductors 90a and 91a, respectively. Accordingly, in the electronic component 10e, the risk of breakages of the linear conductors 90a-90h and 91-91g is significantly reduced or eliminated.

Also, the multilayer body 12 of the electronic component 10e is easy to bend. A detailed description will hereinafter be given with the connection conductors 93a, 94a and the via-hole conductors v2, v16 and v30 as an example.

In the electronic component 10e, the via-hole conductors v2, v16 and v30 are not connected straight. Specifically, the connection conductor 93a is provided between the via-hole conductor v2 and the via-hole conductor v16, and the connection conductor 94a is provided between the via-hole conductor v16 and the via-hole conductor v30. The bedded connection conductors 93a and 94a are easy to bend as compared to the rod-like via-hole conductors v2, v16 and v30. Therefore, when the multilayer body 12 is bent, the connection conductors 93a and 94a bend, and the via-hole conductors v2, v16 and v30 hardly bend. Accordingly, it is possible to bend the multilayer body 12 easily without breaking the via-hole conductors v2, v16 and v30, and the dielectric layers 16a-16e.

In the electronic component 10e, the coil L has a great inductance value. A detailed description will hereinafter be given with the connection conductors 93a, 94a and the via-hole conductors v2, v16 and v30 taken as an example.

The connection conductors 93a, 94a and the via-hole conductors v2, v16 and v30 define a stair-shaped configuration. Therefore, the direction of electric current flowing along the connection conductor 93a and the direction of electric current flowing along the connection conductor 94a are the same. Accordingly, the direction of magnetic field generated around the connection conductor 93a and the direction of magnetic field generated around the connection conductor 94a are the same. Thus, these magnetic fields do not cancel each other. Consequently, in the electronic component 10e, the coil L has a great inductance value.

### Sixth Preferred Embodiment

An electronic component 10f according to a sixth preferred embodiment of the present invention will hereinafter be described with reference to the drawings. FIG. 15B is a perspective view of the electronic component 10f according to the sixth preferred embodiment.

The electronic component 10f is a high-frequency signal line. At the right end and the left end of the electronic component 10f, external electrodes (not illustrated in FIG. 15B) are provided respectively. On the external electrodes, connectors 200a and 200b are provided, respectively. The internal structure of the electronic component 10f is substantially the same as the internal structure of either one of the electronic components 10a-10e, and a detailed description thereof is omitted.

The electronic component 10f has the same effects as the electronic components 10a-10e.

### Other Preferred Embodiments

Electronic components according to the present invention are not limited to the electronic components 10a-10f, and various changes and modifications are possible within the scope of the present invention.

The structures of the electronic components 10a-10f may be combined with one another, for example.

In each of the electronic components 10a-10f, the multilayer body 12 includes dielectric layers stacked on one another. However, the multilayer body 12 may include magnetic layers stacked on one another.

In the electronic component 10c, the coil conductor 50 and the coil conductor 52 spiral in the same direction. However, the coil conductor 50 and the coil conductor 52 may spiral in opposite directions.

In the respective processes of producing the electronic components 10a-10f, a sequential stacking and pressure-bonding method in which dielectric sheets are stacked on one another and subsequently are pressure-bonded together is adopted. However, for example, a printing method in which printing of an insulating layer and printing of a conductive layer are repeated may be adopted. In a case in which ceramic green sheets are used as the dielectric sheets, a sintering step may be carried out after the pressure-bonding step.

The multilayer body 12 does not need to be flexible.

The electronic components 10a-10f preferably are chip components to be mounted on circuit boards or the like. However, each of the electronic components 10a-10f may be produced as a portion of a circuit board. Specifically, the coil L or the coils L1 and L2 of each of the electronic components 10a-10f may be incorporated in a circuit board. In this case, the circuit board is regarded as an electronic component.

In the electronic component 10a, the linear conductive portions 22a and 22c having relatively great line widths and the linear conductive portion 22b having a relatively small line width do not need to be provided on the same dielectric layer. Likewise, the linear conductive portions 26a and 26c having relatively great line widths and the linear conductive portion 26b having a relatively small line width do not need to be provided on the same dielectric layer. However, it is the minimum necessary that the linear conductive portions 26a-26c are provided on one or more dielectric layers arranged lower than the one or more dielectric layers on which the linear conductive portions 22a-22c are provided. This also applies to the electronic components 10b-10f.

As thus far described, various preferred embodiments of the present invention are applicable to electronic components, and are useful especially in downsizing electronic components.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electronic component comprising:
a multilayer body including a plurality of insulating layers stacked on one another in a stacking direction;
a first linear conductor provided on one of the insulating layers and having a first line width;
a second linear conductor provided on one of the insulating layers and having a second line width smaller than the first line width;
a third linear conductor provided on one of the insulating layers that is arranged at one side in the stacking direction of the insulating layer on which the first linear conductor is provided and the insulating layer on which the second linear conductor are provided, and having a third line width; and
a fourth linear conductor provided on one of the insulating layers that is arranged at one side in the stacking direction of the insulating layer on which the first linear conductor is provided and the insulating layer on which the second linear conductor are provided, and having a fourth line width smaller than the first line width and smaller than the third line width; wherein
the first linear conductor and the second linear conductor are arranged in a widthwise direction of the first and the second linear conductors;
the third linear conductor and the fourth linear conductor are arranged in a widthwise direction of the third and the fourth linear conductors;
the first linear conductor and the fourth linear conductor overlap each other in a planar view from the stacking direction;
the second linear conductor and the third linear conductor overlap each other in a planar view from the stacking direction; and
the first, the second, the third and the fourth linear conductors are electrically connected to define a coil.

2. The electronic component according to claim 1, wherein
the first linear conductor and the second linear conductor are connected in series to define a first spiral coil conductor;
the third linear conductor and the fourth linear conductor are connected in series to define a second spiral coil conductor; and
the first spiral coil conductor and the second spiral coil conductor are connected to each other.

3. The electronic component according to claim 2, wherein at least one of the first linear conductor, the second linear conductor, the third linear conductor and the fourth linear conductor has a length substantially corresponding to one turn of the first spiral coil conductor or the second spiral coil conductor.

4. The electronic component according to claim 1, wherein:
the first, the second, the third and the fourth linear conductors extend in a predetermined direction;
one end in the predetermined direction of each of the first, the second, the third and the fourth linear conductors is defined as a first end and another end in the predetermined direction of each of the first, the second, the third and the fourth linear conductors is defined as a second end;
the first end of the first linear conductor is electrically connected to the first end of the third linear conductor arranged at one side in the widthwise direction of the first linear conductor to be adjacent to the first linear conductor in a planar view from the stacking direction;
the second end of the first linear conductor is electrically connected to the second end of the fourth linear conductor arranged to overlap the first linear conductor in a planar view from the stacking direction;
the first end of the second linear conductor is electrically connected to the first end of the fourth linear conductor arranged at one side in the widthwise direction of the second linear conductor to be adjacent to the second linear conductor in a planar view from the stacking direction; and
the second end of the second linear conductor is electrically connected to the second end of the third linear conductor arranged to overlap the second linear conductor in a planar view from the stacking direction.

5. The electronic component according to claim 4, wherein
the first end of the first linear conductor and the first end of the third linear conductor are connected to each other through a plurality of via-hole conductors piercing through the plurality of insulating layers respectively; and
the plurality of via-hole conductors are not arranged straight in a planar view from a direction perpendicular or substantially perpendicular to the stacking direction.

6. The electronic component according to claim 1, wherein
the first linear conductor and the second linear conductor are provided on one of the insulating layers; and
the third linear conductor and the fourth linear conductor are provided on another of the insulating layers.

7. The electronic component according to claim 1, wherein the multilayer body is flexible.

8. The electronic component according to claim 1, wherein the insulating layers are made of liquid crystal polymer.

9. The electronic component according to claim 1, wherein each of the plurality of insulating layers is one of a dielectric layer and a magnetic layer.

10. The electronic component according to claim 1, wherein the coil is a first coil, a second coil is provided in the multilayer body, and the first coil and the second coil spiral in a same direction or spiral in different directions.

11. The electronic component according to claim 1, wherein the electronic component is one of a chip component and a portion of a circuit board.

12. An electronic component comprising:
a multilayer body including a plurality of insulating layers, stacked on one another in a stacking direction;
a first linear conductor provided on one of the insulating layers and having a first line width;
a second linear conductor provided on one of the insulating layers and having a second line width smaller than the first line width;
a third linear conductor provided on one of the insulating layers that is arranged at one side in the stacking direction of the insulating layer on which the first linear conductor is provided and the insulating layer on which the second linear conductor are provided, and having a third line width; and
a fourth linear conductor provided on one of the insulating layers that is arranged at one side in the stacking direction of the insulating layer on which the first linear conductor is provided and the insulating layer on which the second linear conductor are provided, and having a fourth line width smaller than the first line width and smaller than the third line width; wherein
the first linear conductor and the second linear conductor are arranged in a widthwise direction of the first and the second linear conductors;
the third linear conductor and the fourth linear conductor are arranged in a widthwise direction of the third and the fourth linear conductors;
the first linear conductor and the fourth linear conductor overlap each other in a planar view from the stacking direction;
the second linear conductor and the third linear conductor overlap each other in a planar view of the stacking direction;
the first linear conductor and the second linear conductor are electrically connected to define a first coil; and
the third linear conductor and the fourth linear conductor are electrically connected to define a second coil to define a common-mode choke coil in conjunction with the first coil.

13. The electronic component according to claim 12, wherein
the first linear conductor and the second linear conductor are connected in series to define the first coil in a spiral shape; and
the third linear conductor and the fourth linear conductor are connected in series to define the second coil in a spiral shape.

14. The electronic component according to claim 12, wherein
the first linear conductor and the second linear conductor are provided on one of the insulating layers; and
the third linear conductor and the fourth linear conductor are provided on another of the insulating layers.

15. The electronic component according to claim 12, wherein the multilayer body is flexible.

16. The electronic component according to claim 12, wherein the insulating layers are made of liquid crystal polymer.

17. The electronic component according to claim 12, wherein each of the plurality of insulating layers is one of a dielectric layer and a magnetic layer.

18. The electronic component according to claim 12, wherein the coil is a first coil, a second coil is provided in the multilayer body, and the first coil and the second coil spiral in a same direction or spiral in different directions.

19. The electronic component according to claim 12, wherein the electronic component is one of a chip component and a portion of a circuit board.
